(19) United States
(12) Patent Application Publication
(10) Pub. No.: US 2026/0277173 A1
(43) Pub. Date: Sep. 17, 2026

(54) SYSTEM

(71) Applicant: SoftBank Group Corp., Tokyo (JP)

(72) Inventor: Akira FUJIMOTO, Tokyo (JP)

(73) Assignee: SoftBank Group Corp., Tokyo (JP)

(21) Appl. No.: 19/551,618

(22) Filed: Feb. 27, 2026

Related U.S. Application Data
(60) Provisional application No. 63/772,923, filed on Mar. 17, 2025.

(51) Int. Cl. G05B 13/02

(52) U.S. Cl. CPC G05B 13/027

(57) ABSTRACT

A system includes a processor that is configured to collect energy usage data within a home or building as data collection information, acquire external environmental data as external data acquisition information, analyze the data collection information and the external data acquisition information to generate an energy usage optimization plan as generative artificial intelligence processing, and control energy supply and energy saving settings based on the energy usage optimization plan as control processing.

### CROSS-REFERENCE TO RELATED APPLICATION

This application claims the benefit of U.S. Provisional Application No. 63/772,923, filed on Mar. 17, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional home energy management systems typically rely on fixed rules or simple threshold-based control and therefore cannot sufficiently adapt to complex and dynamically changing factors such as detailed in-home energy usage patterns, time-varying electricity tariffs, and external environmental conditions including weather and regional energy supply. As a result, such systems often fail to achieve optimal energy usage in terms of both cost and efficiency, and may not appropriately schedule operation of home appliances during low-tariff periods or adjust energy-saving settings in real time. Furthermore, conventional systems generally do not leverage generative artificial intelligence to analyze large volumes of historical data in conjunction with external data, and thus cannot provide sophisticated, continuously updated optimization plans. Accordingly, there is a need for a smart home system that can automatically collect comprehensive energy usage data, acquire relevant external environmental and tariff data, and generate and update, in real time, an energy usage optimization plan using machine learning and generative artificial intelligence, while controlling energy supply and energy-saving settings based on such a plan.

### SUMMARY

In order to solve the above-described problems, a system according to one embodiment of the present invention comprises a processor configured to collect energy usage data within a home or building as data collection information, acquire external environmental data as external data acquisition information, analyze the data collection information and the external data acquisition information to generate an energy usage optimization plan as generative artificial intelligence processing, and control energy supply and energy saving settings based on the energy usage optimization plan as control processing. In one aspect, the processor is configured to collect, in real time, data from at least one of an electric power meter, a gas meter, a temperature sensor, a humidity sensor, an illuminance sensor, and a smart home appliance, and to transmit the collected data to a database on a cloud. In another aspect, the processor is configured to learn past data using a machine learning algorithm to identify patterns of energy usage, to update, in real time, the energy usage optimization plan in accordance with changes in the external environmental data, and to propose a schedule for operating home appliances during time periods in which an electricity rate is lower. By these means, the system can dynamically and continuously optimize energy usage in the home or building, reduce energy costs, and improve overall energy efficiency.

The term “system” refers to an arrangement of hardware and/or software components that cooperatively perform the functions recited in the claims, including collecting, acquiring, analyzing, and controlling energy-related information.

The term “processor” refers to one or more processing units, such as a central processing unit (CPU), microcontroller, digital signal processor (DSP), or other computing circuitry, that executes instructions to perform the functions specified in the claims.

The term “energy usage data” refers to information indicating consumption or usage of energy resources, including but not limited to electrical power usage, gas usage, and associated temporal or spatial attributes within a home or building.

The term “data collection information” refers to energy usage data and related sensor information that are collected within the home or building by measurement devices such as meters and sensors.

The term “external environmental data” refers to information obtained from outside the home or building, including but not limited to weather information, electricity tariff information, regional energy supply information, and other relevant external conditions.

The term “external data acquisition information” refers to external environmental data that have been obtained and formatted for analysis by the processor.

The term “energy usage optimization plan” refers to a set of one or more control parameters, schedules, or strategies generated by analysis of data collection information and external data acquisition information, which are intended to reduce energy cost, improve energy efficiency, or otherwise optimize energy usage.

The term “generative artificial intelligence processing” refers to processing performed by a generative artificial intelligence model or algorithm that generates an energy usage optimization plan based on analysis of input data including data collection information and external data acquisition information.

The term “control processing” refers to processing by which the processor issues commands or control signals to energy-related devices, systems, or actuators in order to implement the energy usage optimization plan.

The term “energy supply” refers to provision or delivery of energy resources, such as electrical power or gas, to loads within the home or building, including management of supply sources such as power grid, battery storage, or local generation.

The term “energy saving settings” refers to configuration parameters, operating modes, or control setpoints of devices or systems that reduce energy consumption, including but not limited to thermostat settings, lighting levels, and appliance operation modes.

The term “electric power meter” refers to a measurement device that measures electrical power or energy consumption of one or more electrical loads within the home or building.

The term “gas meter” refers to a measurement device that measures gas consumption within the home or building.

The term “temperature sensor” refers to a sensing device that measures temperature at a location in the home or building.

The term “humidity sensor” refers to a sensing device that measures humidity, such as relative humidity, at a location in the home or building.

The term “illuminance sensor” refers to a sensing device that measures illuminance or light intensity, including natural light and/or artificial light, at a location in the home or building.

The term “smart home appliance” refers to an appliance or device in the home or building that is capable of communication with the system and of being monitored or controlled by the processor, including but not limited to washing machines, dishwashers, air conditioners, lighting devices, and smart plugs.

The term “database on a cloud” refers to a data storage system or service provided on a cloud computing infrastructure that is accessible over a network and is configured to store data collected by the system.

The term “machine learning algorithm” refers to an algorithm or model that automatically learns patterns or relationships from past data and uses the learned patterns to perform tasks such as prediction, classification, clustering, or optimization.

The term “patterns of energy usage” refers to recurring or characteristic behaviors in energy consumption over time, across devices, or across locations, which can include temporal trends, seasonal variations, or user-specific behaviors.

The term “time periods in which an electricity rate is lower” refers to defined intervals of time during which the unit cost of electricity, as determined by a tariff or pricing scheme, is lower than in other time intervals.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

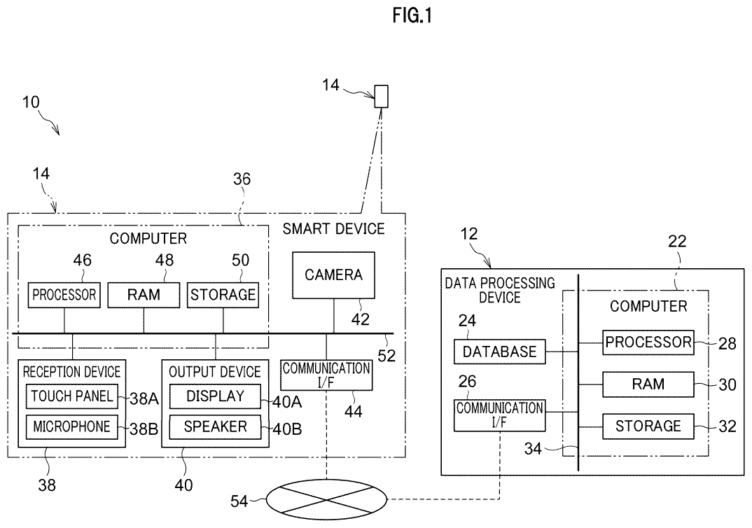

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

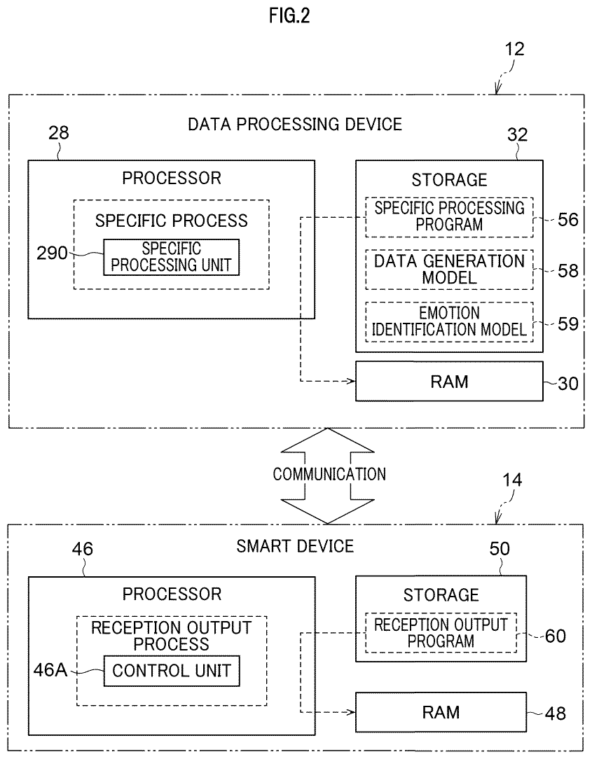

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional smart home energy management systems typically rely on fixed rule sets, static schedules, or pre-trained predictive models that operate on narrowly defined sensor inputs. These approaches suffer from several technical limitations. First, the systems lack a unified representation of heterogeneous time-series data originating from multiple measurement apparatuses and electric apparatuses, such as meters, environmental sensors, and controllable loads. As a result, backend processing components must execute complex, ad hoc data alignment and transformation procedures, which increase processing latency and reduce scalability when the number of devices or time resolution increases.

Second, existing systems generally separate numerical optimization logic from user-facing explanations and from the integration of dynamic external information, such as weather forecasts and time-of-use tariff structures. In many implementations, the backend server executes dedicated optimization algorithms on structured data, while a separate component generates human-readable descriptions or recommendations. This separation hinders consistent use of historical performance feedback and occupant comfort preferences across both optimization and explanation, and leads to duplicated processing flows and model management overhead on the server-side computing infrastructure.

Third, in typical deployments, user preferences and post-hoc evaluations of comfort are only weakly coupled to the underlying computational models. A server often stores preference flags or comfort thresholds and applies them as simple filter conditions or clip operations on pre-computed schedules. This architecture prevents the optimization engine from leveraging rich, contextual feedback—such as observed deviations between planned and realized room temperatures, or qualitative user evaluations—when generating future control plans.

Consequently, the server is unable to iteratively improve control policies at the level of the overall computation pipeline, and must instead rely on manual rule tuning or retraining of specialized models, which is computationally expensive and error-prone.

Fourth, existing smart home controllers typically handle device-level command generation and safety checks in a fragmented manner. Different modules may independently validate temperature ranges, operation windows, and pricing constraints, creating redundant logic paths and inconsistent behavior when plans are invalid or partially infeasible. This fragmentation complicates verification and debugging, and increases processing load due to repeated constraint checks over similar data structures.

Accordingly, there is a need for a technical architecture that improves computer technology in this domain by: (i) unifying heterogeneous in-home and external data into a prompt-based representation suitable for a generative AI model, (ii) configuring the server to generate, verify, and adapt optimization plans via a single integrated computation flow, and (iii) feeding execution feedback and occupant evaluations back into the same prompt-generation process. By structuring the entire optimization loop—data aggregation, feature extraction, prompt construction, generative planning, constraint-based correction, and schedule distribution—as coordinated processing performed by a server-side processor, the system can reduce overall computational complexity, improve responsiveness, and enhance robustness of the control logic over time.

The specific processing by the specific processing unit 290 of the data processing device 12 in Example 1 is realized by the following means.

The present invention provides a server comprising a processor and a memory storing instructions that, when executed by the processor, cause the processor to acquire, from terminal devices associated with a residential or building environment, time-series energy-usage information and environmental information collected by multiple measurement apparatuses and electric apparatuses, aggregate the acquired information by temporal interval and spatial zone, and store the aggregated information in the memory as normalized time-aligned records; to obtain, via a communication network, external environment information and pricing information from external information sources, align the external environment information and pricing information with the aggregated information on a common temporal and spatial basis, and generate feature information including usage-pattern indicators and pricing indicators; to construct a prompt sentence composed of textual information that incorporates the feature information and occupant comfort conditions, supply the prompt sentence as an input to a generative AI model, and receive from the generative AI model energy-usage optimization plan information including, for each interior space, an air-conditioning setting value, an operation start time and an operation end time for each electric apparatus, and a charge amount and a discharge amount for an energy-storage apparatus; to verify the optimization plan information against predetermined constraints including temperature ranges, operation-time conditions, and pricing constraints, correct portions of the optimization plan information that violate the constraints, and convert the corrected optimization plan information into a concrete control schedule in a device-specific format for the terminal devices; to transmit the concrete control schedule to the terminal devices so that the terminal devices control, according to the concrete control schedule, climate-control apparatuses, illumination apparatuses, housekeeping apparatuses, and the energy-storage apparatus, and to receive feedback information including execution results and realized energy-usage data from the terminal devices; and to update at least one of the feature information, the prompt sentence, and instruction conditions for the generative AI model based on the feedback information and occupant-provided evaluation information so as to sequentially improve subsequently generated energy-usage optimization plan information. This enables a unified, processor-implemented optimization loop in which heterogeneous sensor data, external information, occupant preferences, and historical execution feedback are integrated into a single prompt-driven computational pipeline, thereby improving the efficiency, adaptability, and reliability of server-side energy management computations compared to conventional rule-based or statically modeled systems.

The term “processor” refers to one or more hardware computation units, such as a central processing unit or other programmable logic device, that execute machine-readable instructions to perform data processing, control, and communication operations of the system.

The term “memory” refers to one or more hardware storage components, such as volatile or non-volatile storage devices, configured to store instructions and data for access by the processor.

The term “terminal device” refers to an information processing apparatus installed in or associated with a residential or building environment that communicates with the server, interfaces with measurement apparatuses and electric apparatuses, and executes control commands according to a control schedule.

The term “measurement apparatus” refers to any sensing or metering hardware, including but not limited to electric meters, gas meters, temperature sensors, humidity sensors, and illuminance sensors, that generate time-series information representing energy usage or environmental conditions.

The term “electric apparatus” refers to any controllable load or appliance that consumes energy in a residential or building environment, including but not limited to climate-control apparatuses, illumination apparatuses, and housekeeping apparatuses.

The term “climate-control apparatus” refers to any device that adjusts thermal conditions of an interior space, including but not limited to air conditioners, heat pumps, heaters, and ventilation units.

The term “illumination apparatus” refers to any lighting device or lighting system whose on/off state, brightness, color, or other luminous characteristics are controllable.

The term “housekeeping apparatus” refers to any domestic appliance used for household tasks, including but not limited to washing machines, dishwashers, dryers, and cleaning devices.

The term “energy-storage apparatus” refers to any device or system capable of storing energy and later releasing the stored energy, including but not limited to electrochemical batteries and other electrical storage systems.

The term “time-series energy-usage information” refers to data representing energy consumption or flow of a resource over time, recorded at multiple time points or intervals, and associated with at least one measurement apparatus or electric apparatus.

The term “environmental information” refers to data representing physical conditions in or around an interior space, including but not limited to temperature, humidity, illuminance, and other measurable environmental parameters.

The term “external environment information” refers to data obtained from one or more remote information sources outside the residential or building environment, including but not limited to weather forecasts, outdoor temperature, humidity, solar irradiance, and wind-related information.

The term “pricing information” refers to data representing a tariff structure or unit-price values for energy usage, including but not limited to time-of-use pricing, peak and off-peak rates, and other cost-related conditions applied by an energy provider.

The term “usage-pattern indicator” refers to derived information or metrics characterizing temporal or spatial patterns of energy usage, such as averages, peaks, distributions, or correlations determined from time-series energy-usage information.

The term “pricing indicator” refers to derived information or metrics that characterize cost conditions over time, such as relative price levels, peak periods, or cost thresholds computed from pricing information.

The term “feature information” refers to structured or semi-structured data derived from raw time-series energy-usage information, environmental information, external environment information, and pricing information, including usage-pattern indicators and pricing indicators, and used as input context for optimization.

The term “occupant comfort condition” refers to one or more constraints or preferences specified for an interior environment, including but not limited to allowable temperature ranges, humidity ranges, and other comfort-related parameters defined by or for an occupant.

The term “prompt sentence” refers to a text expression or textual data structure that encodes feature information, occupant comfort conditions, and instructions, and that is supplied as an input to a generative AI model to request generation of energy-usage optimization plan information.

The term “generative AI model” refers to a machine-implemented model, such as a neural-network-based language model or other generative model, configured to receive a prompt sentence and output generated information including an energy-usage optimization plan or related structured data.

The term “energy-usage optimization plan information” refers to data generated by the generative AI model or by the processor that specifies recommended energy-related control actions over time, including at least one of air-conditioning setting values, operation schedules for electric apparatuses, and charge and discharge actions for an energy-storage apparatus.

The term “air-conditioning setting value” refers to a control parameter for a climate-control apparatus, including but not limited to a target temperature, operation mode, fan level, or similar setpoint influencing thermal control.

The term “operation start time” refers to a time or time index at which an electric apparatus or function is designated to begin operation according to an energy-usage optimization plan or control schedule.

The term “operation end time” refers to a time or time index at which an electric apparatus or function is designated to terminate operation according to an energy-usage optimization plan or control schedule.

The term “charge amount” refers to a quantity or rate of energy to be stored in an energy-storage apparatus during a specified time interval in accordance with an energy-usage optimization plan.

The term “discharge amount” refers to a quantity or rate of energy to be released from an energy-storage apparatus during a specified time interval in accordance with an energy-usage optimization plan.

The term “temperature range” refers to a lower limit and an upper limit of allowable temperature for an interior space or device operation, used as a constraint when verifying optimization plan information.

The term “operation-time condition” refers to one or more constraints on time or duration during which an apparatus may operate, including allowable time bands, minimum run times, and maximum run times.

The term “pricing constraint” refers to one or more conditions that restrict operation of apparatuses based on pricing information, such as limiting or shifting usage during high-price periods or peak tariff intervals.

The term “concrete control schedule” refers to a device-specific and time-resolved set of control commands or setpoints derived from energy-usage optimization plan information, suitable for direct execution by terminal devices to control apparatuses.

The term “execution result” refers to data indicating an outcome of a control command or control schedule, including at least one of success or failure status, actual device states, and realized energy usage.

The term “feedback information” refers to data transmitted from terminal devices to the server that includes execution results, updated time-series energy-usage information, and optionally measured environmental information following execution of a control schedule.

The term “evaluation information” refers to data representing an assessment of system behavior, including occupant-provided evaluations of comfort or satisfaction and computed metrics such as peak-power reduction or cost reduction.

The term “instruction conditions for the generative AI model” refers to parameters, constraints, or formatting requirements specified within or in association with a prompt sentence, which guide the generative AI model in producing energy-usage optimization plan information.

The term “interior space” refers to any defined zone within a residential or building environment, such as a room, area, or floor, to which environmental measurements and control actions are associated.

The term “user operation apparatus” refers to any input or interface device operated by an occupant or administrator, including but not limited to a mobile terminal, a fixed display device, or a control panel, through which comfort conditions, preferences, or evaluations are provided to the server.

In one embodiment, a server, a terminal, and a user cooperate to implement the claimed system. The server executes a software stack on general-purpose computing hardware, the terminal executes embedded software on in-home control hardware, and the user interacts through a user operation apparatus such as a mobile communication device or a fixed display apparatus.

The server uses a processor such as a multi-core central processing unit, optionally combined with an accelerator such as a graphics processing unit, and a memory such as a non-transitory semiconductor memory and a magnetic or solid-state storage device. The server executes an operating system such as a general-purpose server operating system and application programs implemented, for example, in a high-level programming language such as a scripting language or a compiled language. The server further uses software libraries such as a numerical computation library, a data-frame manipulation library, and a machine learning library, and a generative AI framework implementing a transformer-based neural network as the generative AI model.

The terminal uses an embedded processor such as a reduced-instruction-set microprocessor or a system-on-chip with integrated communication interfaces, and runs an embedded operating system such as an embedded distribution of a general-purpose operating system. The terminal interfaces with measurement apparatuses and electric apparatuses using communication protocols such as a wireless local-area protocol, a short-range wireless protocol, or a low-power mesh protocol. The terminal also includes a local non-volatile storage that stores control schedules and local logs.

The server acquires time-series energy-usage information and environmental information from the terminal. The terminal collects raw measurement values from an electric meter, a gas meter, a temperature sensor, a humidity sensor, an illuminance sensor, and controllable electric apparatuses by periodically issuing device-specific read commands. The terminal stores each raw measurement together with a local timestamp and an identifier for an interior space and a device.

The terminal aggregates raw values into normalized time-series records with a fixed temporal resolution, for example, five minutes or fifteen minutes, and converts device-specific units into standardized units such as kilowatt-hours, degrees Celsius, percent humidity, and lux.

The server receives the aggregated measurements from the terminal via a secure application programming interface. The server stores the aggregated measurements in a time-series data structure indexed by a composite key comprising a home identifier, an interior space identifier, a device identifier, and a time index. The server uses a relational or time-series database management system to persist these records. By normalizing all incoming measurements into a common time-indexed record format, the server reduces the computational overhead that would otherwise be required to reconcile heterogeneous device-specific formats, thereby improving data management efficiency and reducing processing latency.

The server acquires external environment information and pricing information from external information sources connected through a wide-area network. The server calls endpoints of a weather information service and a tariff information service, receives responses containing, for example, hourly outdoor temperature forecasts, humidity forecasts, solar irradiance estimates, and time-of-use unit prices, and stores these responses in a separate time-series data structure.

The server aligns timestamps between in-home data and external data by resampling both data sets onto a common time grid.

The server generates feature information by computing usage-pattern indicators and pricing indicators. The server uses a numerical computation library to compute, for each interior space and device, rolling averages and rolling maxima of power consumption, ratios of peak-period consumption to off-peak consumption, and correlations between outdoor temperature and climate-control power usage. The server computes pricing indicators such as relative price level indices, flags for peak and super-peak periods, and estimated marginal cost per additional kilowatt-hour. The server stores feature information in a structured record that references the corresponding time-series intervals and devices.

The server constructs a prompt sentence for the generative AI model by converting the feature information and occupant comfort conditions into textual form. The server retrieves, from a user operation apparatus, data indicating an allowable temperature range for each interior space, an allowable operation time band for each electric apparatus, and a comfort priority weight. The server encodes these constraints into human-readable but machine-parsable text segments. The server concatenates: (i) a system instruction describing the optimization objective and output format, (ii) a summary of feature information, and (iii) a description of occupant comfort conditions, to form a prompt sentence.

For example, the server constructs a prompt sentence such as:

“You are an energy-management assistant for a residential building. Over the past 7 days, the average daily energy usage of this home was 14.5 kWh. Approximately 40% of the energy was consumed during peak-price hours. The living room typically used 4.2 kWh per day for air conditioning, with an average indoor temperature of 25.5° C. when the outdoor temperature was 32° C.

For tomorrow, the forecast indicates outdoor temperatures between 26° C. and 34° C., with peak electricity prices from 13:00-16:00 and 19:00-21:00.

The occupant requires the living room temperature to stay between 24° C. and 27° C. from 18:00-23:00, and the bedroom temperature to stay between 23° C. and 26° C. from 22:00-07:00. The washing machine needs 2 continuous hours for a cycle, and the dishwasher needs 2 continuous hours for a cycle.

Generate a 24-hour energy-usage plan that minimizes total electricity cost while respecting these constraints. Output a schedule from 00:00 to 23:00 specifying, for each hour, the target set temperature for each air conditioner and the on/off state of the washing machine and dishwasher.”

In another example, the server constructs a prompt sentence for real-time setpoint adjustment such as:

“Current indoor conditions are: living room 27.8° C. and 60% humidity; bedroom 26.2° C. and 55% humidity. The current outdoor temperature is 33° C. with strong sunlight, and the electricity price will be at the highest tier for the next 2 hours.

The occupant prefers moderate comfort with some cost savings.

Propose optimal set temperatures for the living-room and bedroom air conditioners for the next 3 hours. Explain briefly how these settings reduce energy consumption without causing discomfort. Then provide a final list of recommendations, each specifying room, set temperature, start time, and end time.”

The server supplies the prompt sentence to a generative AI model implemented as a transformer-based neural network. The server uses a model comprising multiple layers of self-attention and feed-forward sublayers, with parameters (weights and biases) stored in the memory. The server executes the generative AI model either on a local accelerator or by forwarding the prompt sentence to an inference endpoint implemented on a separate hardware platform.

The server processes tokenized text of the prompt sentence using the transformer architecture. Each token is mapped to an embedding vector. The server applies multi-head self-attention operations to compute context-dependent representations, and applies feed-forward networks with non-linear activation functions to update the hidden state. The server generates output tokens sequentially under an auto-regressive decoding scheme, with a sampling or beam search algorithm constrained to produce a structured or semi-structured text representation of an energy-usage optimization plan.

The server treats the generative AI model not as a black box, but as a component configured with explicit instruction conditions within the prompt sentence. For example, the server specifies in the prompt that outputs must be organized chronologically and must indicate numeric setpoints within an allowed range. The server further restricts the model behavior by embedding examples of acceptable and unacceptable outputs in a preamble section of the prompt during fine-tuning or instruction-prompt design. This design reduces ambiguity and computational post-processing overhead on the server.

The server receives the generated text from the generative AI model and parses the text into a machine-readable energy-usage optimization plan information structure. The server applies a parser that extracts, for each time interval, an air-conditioning setting value, an operation start time and operation end time for each electric apparatus, and a charge and discharge pattern for an energy-storage apparatus if present. The server then verifies the generated plan against pre-configured constraints. The server checks, for each interior space, that planned temperatures remain within the occupant's allowable range; checks that an operation window for an electric apparatus does not violate user-specified restricted periods; and checks that aggregate power during high-price periods does not exceed a pre-defined peak threshold.

When the server detects a violation, the server performs correction by applying constraint projection rules. For example, if a set temperature falls below the minimum permitted value, the server replaces it with the minimum value. If an appliance is scheduled to operate over disallowed hours, the server shifts the operation window to the nearest allowed interval that still satisfies the required duration. These correction rules are specified as deterministic algorithms implemented in the server software and differ from conventional rule-based schedulers because they operate on candidate plans generated from high-dimensional, context-rich prompts, rather than from static rule tables.

The server converts the corrected energy-usage optimization plan information into a concrete control schedule. The server maps logical device identifiers into terminal-specific device addresses or topics used by the communication protocol. The server creates, for each device, a sequence of control commands, each annotated with execution time, target setpoint, and any necessary mode or parameter. The server stores the concrete control schedule in a data structure optimized for time-indexed access, such as an array of ordered control events, and transmits the schedule to the terminal.

The terminal receives the concrete control schedule from the server and stores it in its local memory. The terminal then controls physical apparatuses in accordance with the schedule. The terminal translates generic control parameters into device-specific commands, such as a structured message for a climate-control apparatus specifying mode, target temperature, and fan speed, or a simple on/off signal for a housekeeping apparatus. The terminal issues these commands via wireless or wired communication interfaces to the appropriate devices.

The terminal also monitors execution results through device responses and local sensors. For example, after issuing a command to adjust an air-conditioning setpoint, the terminal reads a confirmation status from the device and checks whether the room temperature begins to move toward the desired range. The terminal logs success or error codes and logs the realized energy usage during and after the commanded interval.

The server receives feedback information from the terminal, including execution results and updated energy-usage measurements. The server compares the realized consumption curve and room temperature trajectories with the planned schedule. The server computes error measures, such as mean absolute error between planned and actual temperature, percentage deviation of peak power, and difference in total cost relative to a baseline. The server also receives evaluation information from the user operation apparatus, such as the user indicating that the living room felt too warm during a specific period.

The server integrates the computed error measures and user evaluations into subsequent prompt sentences. For example, the server constructs a new prompt sentence as:

“In the previous 24-hour plan, peak consumption was reduced by 18% compared to the baseline, but the occupant reported feeling too hot in the living room between 19:00 and 20:00. During that time, the planned temperature was 27° C., but the actual measured temperature averaged 27.8° C.

For the next 24-hour plan, keep the living room temperature below 26° C. between 18:00 and 22:00, while still aiming to minimize electricity cost and avoid operation of major appliances during peak-price hours. Use the historical performance information to adjust the schedule.” The server uses such prompt sentences to adapt the behavior of the generative AI model over time. By repeatedly embedding historical performance summaries, constraint changes, and user evaluations directly into the textual context seen by the generative AI model, the server achieves an iterative optimization loop that does not require retraining the model for each new preference, but still exploits the model's high-dimensional reasoning capability. This architecture improves computational efficiency because the server can adapt policies through low-cost prompt updates and lightweight parsing and correction, instead of executing a separate re-optimization algorithm for every scenario.

From a computer-technology standpoint, the server improves processing speed and scalability by (i) normalizing heterogeneous time-series data into a unified record structure before feature extraction, (ii) reusing the generative AI model as a single planning engine driven by prompt sentences that encode both data and constraints, and (iii) centralizing constraint checking and correction into a deterministic post-processing module with optimized data access patterns. These measures reduce redundant computation across separate subsystems and avoid repeated model calls for small variations in inputs.

The server also improves accuracy and robustness of control decisions. Because the generative AI model consumes rich feature information and detailed comfort conditions, the server obtains candidate plans that already account for complex temporal and cross-device relationships. The subsequent constraint-based correction algorithm, implemented as specific projection operations on the candidate plan, ensures that no unsafe or unacceptable schedule is issued to the terminal.

The combination of high-dimensional generative planning with deterministic constraint enforcement yields lower error in peak-load prediction and lower incidence of infeasible schedules compared to purely rule-based or purely model-based controllers.

The terminal benefits from reduced communication load and lower local processing requirements. The terminal receives a compact control schedule, rather than raw external data or the full optimization logic, and only needs to execute a straightforward sequence of commands and simple checks. As a result, the terminal can be implemented on lower-power hardware while still contributing to high-quality control of physical apparatuses. This configuration demonstrates a technical implementation that goes beyond mere automation of human scheduling; it changes the internal data flow and computational structure of the client-server architecture.

In alternative embodiments, the server replaces the transformer-based generative AI model with another generative model architecture, such as a recurrent neural-network-based sequence model or a hybrid model combining a feed-forward neural network with a rule-based planner. The server may also vary the feature information, for example, by incorporating occupancy detection signals or weekly seasonality indicators, or by using different error functions when evaluating plan performance. The server may apply different loss functions, such as a weighted sum of cost error and comfort deviation, during an offline training phase of the generative AI model.

In another variant, the server uses a separate neural network to compress raw time-series data into latent feature vectors, which are then decoded into text segments inserted into the prompt sentence. In yet another variant, the server applies data augmentation techniques to synthetically generate additional historical scenarios for fine-tuning of the generative AI model, thereby improving the model's ability to handle edge cases such as abrupt weather changes or tariff events.

In all embodiments, the server, the terminal, and the user jointly operate the system such that the generative AI model and the prompt sentence mechanism are tightly integrated with physical device control. The server does not merely create abstract recommendations; instead, the server produces device-level schedules that the terminal executes to adjust air-conditioning, lighting, housekeeping operations, and energy storage in the real world. This tight integration between prompt-driven generative planning, structured constraint enforcement, and physical apparatus control results in concrete technical effects, including reduced peak power usage, reduced computation overhead for complex scheduling, improved accuracy of comfort maintenance, and improved responsiveness of the overall energy management system.

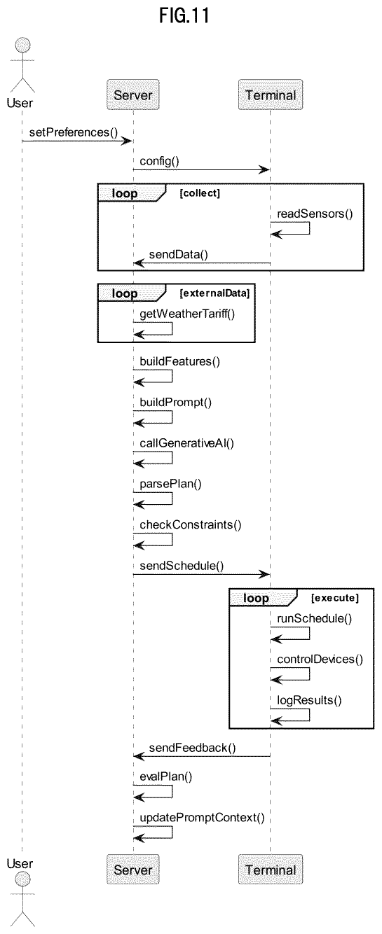

The following describes the processing flow using FIG. 11.

### Step 1:

Terminal acquires raw measurement data.

Terminal receives, as input, signals from an electric meter, a gas meter, temperature sensors, humidity sensors, illuminance sensors, and smart electric apparatuses. Terminal periodically issues read commands via local communication interfaces and obtains raw values such as instantaneous power, gas flow, temperature, relative humidity, and illuminance, each associated with a local timestamp and device identifier. Terminal converts pulse counts and device-specific units into standardized units (for example, watts, kilowatt-hours, cubic meters, degrees Celsius, percent, and lux) and outputs normalized raw measurement records of the form {timestamp, room_id, device_id, metric_type, value}.

### Step 2:

Terminal aggregates and normalizes time-series data.

Terminal receives, as input, the normalized raw measurement records from Step 1. Terminal groups the records by fixed time interval (for example, every 5 minutes) and by room_id and device_id. Terminal computes aggregated statistics such as average power, minimum and maximum temperature, and average humidity within each interval. Terminal also converts instantaneous power readings to energy values per interval (for example, watt-minutes to kilowatt-hours). Terminal stores the aggregated results in a local time-indexed table and outputs aggregated measurement blocks, each block containing a set of aggregated records for a specific time window.

### Step 3:

Terminal uploads aggregated data to server.

Terminal receives, as input, the aggregated measurement blocks from Step 2 and connection parameters for a server endpoint. Terminal packages recent aggregated records that have not yet been transmitted into a structured message, attaches identifiers such as home_id and terminal_id, and applies data compression if configured. Terminal opens a secure connection to server, transmits the message, and waits for an acknowledgment. Terminal marks successfully transmitted records as uploaded in its local store and outputs a transmission status indicating success or failure for each batch.

### Step 4:

Server ingests and stores time-series data.

Server receives, as input, the structured measurement messages from multiple terminals. Server validates message format, authenticates terminal_id and home_id, and parses each aggregated record. Server maps each record into an internal time-series schema with fields such as {home_id, room_id, device_id, time_slot, metric_type, value}. Server writes the records into a centralized time-series database and may create indices on home_id and time_slot to accelerate queries. Server outputs stored and indexed time-series data ready for further processing.

### Step 5:

Server acquires external environment and pricing information.

Server receives, as input, configuration for external information sources and time ranges of interest. Server calls external application programming interfaces of weather information services and tariff information services, specifying location and forecast horizon. Server parses the responses, extracts fields such as forecast temperature, humidity, solar irradiance, and time-of-use unit prices, and aligns timestamps to a standard time grid (for example, hourly). Server stores the processed external environment and pricing information in an external data table keyed by location_id and time_slot, and outputs a set of aligned external data records.

### Step 6:

Server generates feature information from in-home and external data.

Server receives, as input, the stored time-series measurements from Step 4 and the external data records from Step 5. Server queries a specified history window (for example, the last 7 days) of data for each home_id and computes usage-pattern indicators such as average daily energy usage, peak load during defined tariff periods, appliance-specific consumption profiles, and correlations between outdoor temperature and air-conditioning power. Server computes pricing indicators such as relative price levels per hour, flags for high-price intervals, and expected cost impact of shifting loads. Server combines these indicators into feature information records associated with each home_id and time horizon and outputs feature vectors or feature summaries for subsequent use in prompt construction.

### Step 7:

Server incorporates occupant comfort conditions and device constraints.

Server receives, as input, user preference data from a user operation apparatus, including allowable temperature ranges per room, allowable operation time bands per appliance, and a comfort-versus-cost priority parameter. Server also receives device constraint data such as minimum and maximum setpoints for each climate-control apparatus and minimum run-time requirements for each housekeeping apparatus. Server merges this constraint information with feature information from Step 6 by linking on home_id and device identifiers. Server outputs a consolidated constraint profile for each home, consisting of comfort constraints and device-level operational limits.

### Step 8:

Server constructs a prompt sentence for the generative AI model.

Server receives, as input, the feature information from Step 6 and the consolidated constraint profile from Step 7. Server converts numerical and categorical features into descriptive text segments that summarize past energy usage, expected weather and prices, and user preferences.

Server also embeds explicit instructions regarding optimization objectives and output format.

Server concatenates these segments into a single prompt sentence that will be supplied to the generative AI model. For example, server constructs a prompt such as:

“Over the past 7 days, the average daily energy usage of this home was 14.5 kWh, and 40% of the energy was consumed during peak-price hours. For tomorrow, the outdoor temperature is forecast to range from 26° C. to 34° C., with peak prices from 13:00-16:00 and 19:00-21:00. The occupant requires the living room temperature to stay between 24° C. and 27° C. from 18:00-23:00 and the bedroom temperature to stay between 23° C. and 26° C. from 22:00-07:00. The washing machine and dishwasher each require 2 continuous hours. Generate a 24-hour energy-usage plan that minimizes total electricity cost while respecting all constraints and specify, for each hour, the target set temperature for each air conditioner and the on/off state of the washing machine and dishwasher.”

Server outputs the completed prompt sentence as a text string.

### Step 9:

Server invokes the generative AI model with the prompt sentence.

Server receives, as input, the prompt sentence from Step 8. Server tokenizes the prompt sentence into subword units, maps each token to an embedding vector, and feeds the sequence into a transformer-based generative AI model consisting of stacked self-attention and feed-forward layers. Server executes the model to compute attention weights and hidden vectors at each layer and decodes output tokens auto-regressively to form a textual response representing an energy-usage optimization plan. Server collects the generated tokens, reconstructs the response text, and outputs the model output, which contains proposed schedules and setpoints in natural language or semi-structured text.

### Step 10:

Server parses and structures the optimization plan information.

Server receives, as input, the generative AI model output from Step 9. Server applies pattern-matching and parsing rules to extract structured elements such as time intervals, room names, device names, set temperatures, and on/off states. Server converts extracted textual references into internal identifiers (for example, mapping “living room AC” to device_id “ac_living_1”) and aligns the derived control entries with standardized time_slots. Based on this parsing, server creates a structured optimization plan record, containing, for each time_slot and device, proposed values such as target temperature or operation state. Server outputs the structured optimization plan information as a data table or list of control entries.

### Step 11:

Server verifies and corrects the optimization plan according to constraints.

Server receives, as input, the structured optimization plan information from Step 10 and the consolidated constraint profile from Step 7. Server iterates through each planned control entry and compares the proposed set temperature or operation window against the applicable temperature ranges, operation-time conditions, and pricing constraints. For each violation, server adjusts the corresponding control parameter, for example, by clipping a set temperature to the nearest allowed boundary or by shifting an appliance operation out of disallowed time bands into the nearest valid slot that satisfies duration requirements. Server also recomputes per-slot power estimates to ensure aggregate load in high-price periods does not exceed configured thresholds. Server outputs a corrected and constraint-compliant optimization plan.

### Step 12:

Server generates a concrete control schedule for terminal execution.

Server receives, as input, the corrected optimization plan from Step 11 and the device mapping information that links logical device identifiers to terminal-specific addresses or control topics. Server transforms each abstract control entry into one or more device commands that include a target execution time, a mode identifier, and any numerical setpoints required by the device protocol. Server orders these commands chronologically and groups them by terminal_id, creating for each terminal a concrete control schedule suited to its local device interfaces. Server outputs terminal-specific control schedules as structured messages ready for transmission.

### Step 13:

Server transmits the control schedule to terminal.

Server receives, as input, the terminal-specific control schedules from Step 12. Server opens secure communication sessions with each terminal, serializes the control schedule into a message format accepted by the terminal, and transmits the schedule along with a plan identifier. Server waits for acknowledgments from terminals, records the transmission status, and may update an internal state indicating that a given plan is active for a particular home. Server outputs a confirmation log associating each plan identifier with its targeted terminals.

### Step 14:

Terminal executes scheduled control commands on apparatuses.

Terminal receives, as input, the concrete control schedule from Step 13. Terminal stores the schedule in local memory and initializes a scheduler that triggers control events at their specified times. At each trigger, terminal translates the scheduled parameters into device-specific commands, such as setting an air conditioner to a defined temperature or switching a housekeeping appliance on or off Terminal sends the commands via appropriate communication interfaces to the relevant apparatuses and listens for acknowledgment messages or status updates. Terminal then records execution status and any device-reported values, such as resulting temperatures or power draws. Terminal outputs a log of executed commands and observed outcomes.

### Step 15:

Terminal collects feedback data for reporting.

Terminal receives, as input, the execution logs from Step 14 and ongoing measurement data from local sensors. Terminal associates each measurement and status update with the corresponding control event by time and device identifier. Terminal computes summary statistics such as realized average temperature during each scheduled period, actual energy consumed by each apparatus during its active intervals, and any command failures. Terminal packages this information into a feedback report containing both raw measurements and summarized performance metrics. Terminal outputs the feedback report to be sent to server.

### Step 16:

Server receives feedback and evaluates plan performance.

Server receives, as input, the feedback reports from terminals generated in Step 15. Server stores the received data in performance tables linked to plan identifiers, and compares the realized energy usage and environmental conditions against the planned values from the optimization plan. Server computes evaluation metrics, such as deviation between planned and actual temperature trajectories, peak-power reduction achieved compared to a baseline, and total cost difference relative to an unoptimized schedule. Server also merges any user evaluation information, such as comfort ratings provided via a user operation apparatus. Server outputs updated performance metrics and annotated historical records for each plan.

### Step 17:

Server updates future prompt sentences using performance and user feedback.

Server receives, as input, the performance metrics from Step 16 and the latest user-specified comfort preferences. Server summarizes key deviations and user feedback into textual descriptions, for example indicating that a previous plan reduced peak power by a certain percentage but caused discomfort in a specific time window. Server appends these descriptions to or integrates them within the contextual portion of the next prompt sentence, while also updating constraints in accordance with revised user preferences. Server thus generates a new, feedback-aware prompt sentence for the generative AI model, refining its subsequent optimization behavior. Server outputs the updated prompt sentence, which becomes the input to Step 9 in a subsequent planning cycle.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional energy management systems for facilities and data centers generally rely on static rule sets or manually designed optimization logic executing on a computer system. Such systems typically process internal measurement data and, in some cases, external environment data, but they often treat these data streams in a siloed manner, with limited temporal alignment and insufficient handling of missing or abnormal values. As a result, the computer system may generate control outputs based on inconsistent or low-quality data, leading to suboptimal energy usage and frequent need for human intervention.

Furthermore, although recent advances in generative AI models provide powerful capabilities for reasoning over complex constraints and generating sophisticated optimization plans, conventional systems do not tightly integrate such models into an end-to-end control pipeline. In many existing approaches, a generative AI model is used only as an advisory tool, producing free-form text that a human operator must interpret, validate, and translate into concrete control commands. This manual step introduces latency, inconsistency, and a risk of error, and prevents the computer system from autonomously exploiting the full potential of the generative AI model. In addition, traditional systems lack a structured mechanism for constructing prompt sentences and associated structured data that accurately reflect the facility's operational constraints, safety limits, and optimization objectives in a machine-processable manner. Without systematic prompt generation and feedback from executed plans, the generative AI model may produce control proposals that are incomplete, infeasible, or misaligned with real-world device capabilities. This leads to inefficiencies in the computer's use of the generative AI model and can degrade the robustness and predictability of the control loop.

Moreover, known systems do not sufficiently leverage closed-loop learning at the system level. While some solutions may log data for offline analysis, they do not use the logged execution results to refine the internal rule sets for validating AI-generated plans, to adapt templates of prompt sentences for future interactions with the generative AI model, or to tune predictive models used for forecasting. Consequently, the underlying computer architecture is not improved over time: the same suboptimal prompt patterns and verification rules are repeatedly applied, limiting the achievable gains in energy cost reduction, energy efficiency, and operational stability.

Therefore, there is a need for an improved computer-implemented system that: (i) programmatically synchronizes and cleans internal and external data streams into unified time-series data; (ii) automatically constructs structured prompt sentences and associated data tailored to a generative AI model; (iii) automatically parses, validates, and translates AI-generated optimization plans into concrete device control commands; and (iv) persistently learns from historical data and execution outcomes to refine prompt templates, verification rules, and predictive models. Such a system would improve how the computer itself performs data preparation, AI interaction, and control decision-making, thereby enhancing the efficiency, reliability, and autonomy of energy optimization operations.

The specific processing by the specific processing unit 290 of the data processing device 12 in Application Example 1 is realized by the following means.

The present invention provides a server comprising a processor configured to acquire internal energy-related measurement data and external environment data into a unified time-series structure, to perform feature extraction to compute aggregated and derived indicators for equipment groups and space regions, to automatically construct a prompt sentence and associated structured data that describe the indicators, operational constraints, and optimization objectives for a generative AI model, to transmit the prompt sentence and the associated structured data to the generative AI model and receive an optimization plan in a machine-readable format, to parse and verify individual control actions in the optimization plan against predetermined safety constraints and operational constraints to generate a validated control plan, and to output concrete control commands to a plurality of energy-related devices and environmental control devices based on the validated control plan, while storing historical data, plans, and execution results and updating at least one of a rule set for plan verification, a prompt sentence template, and parameters of a predictive model based on analysis of the stored information. This enables the computer system itself to perform improved, automated end-to-end energy optimization by enhancing the quality of input data and prompts supplied to the generative AI model, by systematically constraining and structuring the model's output into safe and executable control commands, and by iteratively refining its internal control and prompting logic based on historical outcomes, resulting in more efficient, reliable, and adaptive energy management operations.

The term “processor” refers to a hardware computing element or a combination of hardware computing elements that execute instructions to perform data acquisition, data processing, model interaction, and device control operations, including but not limited to a central processing unit, a microcontroller, or a programmable logic device.

The term “internal data acquisition unit” refers to a functional module implemented by the processor and associated interfaces that obtains energy-related measurement data from measurement devices located within a controlled facility.

The term “energy-related measurement data” refers to data representing at least one of power consumption, energy consumption, electrical characteristics, environmental conditions, and operational states of equipment within a controlled facility.

The term “measurement device” refers to any sensing or metering apparatus configured to measure physical or operational quantities, including but not limited to power meters, environmental sensors, and device state monitors.

The term “controlled facility” refers to a physical space in which energy usage and environmental conditions are monitored and controlled, including but not limited to a building, a part of a building, or a data center.

The term “environmental condition value” refers to a measured or estimated quantity representing a physical condition of the environment, including but not limited to temperature, humidity, and airflow.

The term “operational state value” refers to a measured or inferred indication of an operating condition of equipment, including but not limited to on/off state, power mode, utilization level, and performance level.

The term “storage unit” refers to a computer-readable memory or a combination of memories configured to store data, configuration information, and control plans, including but not limited to volatile memory, non-volatile memory, or external storage.

The term “external data acquisition unit” refers to a functional module implemented by the processor and associated communication interfaces that acquires external environment data from an external information source via a communication network.

The term “external environment data” refers to data obtained from outside the controlled facility that influence or characterize energy usage conditions, including but not limited to energy price information, weather information, and information on availability of an energy supply source.

The term “energy resource” refers to any source of energy consumed by equipment in the controlled facility, including but not limited to electrical energy, thermal energy, and renewably generated energy.

The term “energy supply source” refers to a provider or source of an energy resource, including but not limited to a power grid, an on-site generation system, and an energy storage system.

The term “data processing unit” refers to a functional module implemented by the processor that processes, synchronizes, cleans, and transforms data, including internal data and external data, to generate unified time-series data and derived indicators.

The term “data synchronization processing” refers to processing that temporally aligns multiple data streams, including assigning common time intervals or time stamps to measurement data and external environment data.

The term “data cleaning processing” refers to processing that improves data quality, including handling missing values, interpolating data, detecting abnormal values, and correcting or discarding erroneous records.

The term “unified time-series data” refers to data structures in which internal measurement data and external environment data are temporally aligned and combined into consistent time-indexed records.

The term “feature extraction processing” refers to processing that derives higher-level indicators or metrics from raw or unified time-series data, including statistical aggregations and computed indices.

The term “aggregated indicator” refers to a value representing a summary or combination of multiple data points over a time range or a group of equipment, including but not limited to averages, peaks, and totals.

The term “derived indicator” refers to a computed value obtained from one or more underlying measurements or aggregated indicators, including but not limited to ratios, efficiencies, and performance indices.

The term “equipment group” refers to a logical or physical grouping of equipment units within the controlled facility, defined according to criteria such as function, location, or application.

The term “space region” refers to a defined physical area within the controlled facility, including but not limited to a room, a zone, an aisle, or a partitioned section.

The term “prompt generation unit” refers to a functional module implemented by the processor that constructs a prompt sentence and associated structured data for input to a generative AI model.

The term “prompt sentence” refers to a sequence of characters expressing, in natural language or a structured format, contextual information, constraints, and objectives provided to a generative AI model to guide generation of an output.

The term “generative AI model” refers to a machine-implemented model configured to generate content such as optimization plans or textual responses in response to an input, including but not limited to a neural network-based language model.

The term “optimization objective” refers to a target or criterion that the system attempts to improve or optimize, including but not limited to reduction of energy cost, improvement of energy efficiency, or enhancement of operational stability.

The term “structured data” refers to data organized in a format with explicit structure, including but not limited to tabular data, key-value pairs, or serialized objects suitable for machine processing.

The term “model execution unit” refers to a functional module implemented by the processor that transmits a prompt sentence and associated structured data to a generative AI model and receives a generated result from the generative AI model.

The term “interface” refers to a logical or physical connection that enables data exchange between the system and an external entity, including but not limited to an application programming interface or a communication protocol endpoint.

The term “optimization plan” refers to information output by the generative AI model describing proposed control actions or operational settings over time for equipment and devices, in order to achieve at least one optimization objective.

The term “machine-readable format” refers to a representation of information that is structured so that a computer can parse and process the information without human interpretation, including but not limited to a markup language or a serialized data format.

The term “time-stamped control action” refers to an action associated with a specific time or time interval, specifying a change in an operational state, setting, or parameter of a device.

The term “plan interpretation unit” refers to a functional module implemented by the processor that analyzes an optimization plan, extracts individual control actions, and performs verification of those actions against constraints.

The term “safety constraint” refers to a condition or rule that prevents operation of equipment or devices in a manner that could cause damage, malfunction, or unsafe environmental conditions.

The term “operational constraint” refers to a condition or rule related to availability, performance, or service quality that restricts how equipment or devices may be controlled or scheduled.

The term “validated control plan” refers to a control plan obtained from an optimization plan after verification and possible modification or removal of actions so that the remaining actions satisfy predetermined safety constraints and operational constraints.

The term “control unit” refers to a functional module implemented by the processor that outputs concrete control commands to devices and systems in order to implement a validated control plan.

The term “control interface” refers to an interface used by the control unit to send commands to devices or subsystems, including but not limited to communication protocols and device-specific control channels.

The term “energy-related device” refers to equipment that consumes, converts, or manages energy within the controlled facility, including but not limited to computing equipment, power distribution equipment, and power conditioning equipment.

The term “environmental control device” refers to equipment that adjusts or maintains environmental conditions within the controlled facility, including but not limited to cooling equipment, ventilation equipment, and air-handling equipment.

The term “user terminal” refers to an information processing device operated by a user to interact with the server, including but not limited to a personal computer, a handheld device, or a workstation.

The term “configuration information” refers to data specifying operational parameters, constraints, preferences, and settings used by the server to construct prompts, verify optimization plans, and control devices.

The term “predictive model” refers to a computational model configured to estimate or forecast future values of quantities such as energy usage, load, or environmental conditions based on historical data.

The term “rule set” refers to a group of rules or conditions used to evaluate or modify an optimization plan, including but not limited to constraints for safety verification and operational feasibility assessment.

The term “prompt sentence template” refers to a predefined structure or pattern for a prompt sentence that includes placeholders for data, constraints, and objectives, to be filled or adapted at runtime.

The term “historical record” refers to stored data that represent past values of measurements, plans, control actions, and execution outcomes, used for analysis, evaluation, or model updating.

The term “execution result” refers to data representing the actual behavior or outcome observed after implementing control commands, including but not limited to actual energy consumption, actual environmental conditions, and occurrence of events.

In an embodiment, the server implements an energy optimization system for a controlled facility such as a data center or building. The server includes at least one processor, at least one memory storing instructions and data structures, and at least one communication interface connected to internal measurement devices, external information sources, and controllable equipment. The terminal includes a general-purpose computing device, such as a personal computer or mobile device, executing a web browser or dedicated client software to interact with the server over a communication network. The user operates the terminal to configure constraints, review optimization results, and optionally provide free-form prompt sentences.

The server executes software modules implemented, for example, using a general-purpose operating system, a database management system, and a data-processing framework. In one implementation, the server uses a Unix-like operating system, a relational or time-series database such as a structured query database or a time-indexed measurement store, and a scripting environment such as a Python runtime with data-analysis libraries including a tabular data library and a numerical computation library. The server also uses a machine-learning framework such as a deep-learning library to train and execute predictive models and a large-language-model framework or external service to host or access a generative AI model.

The server acquires internal measurement data from power meters, environmental sensors, and device-state monitors installed in the controlled facility. For example, the server uses an industrial communication protocol such as a register-based communication protocol over TCP/IP to read instantaneous and accumulated power values from rack-level meters associated with information-processing equipment. The server converts raw register values into physical units such as watts and kilowatt-hours and stores them in a time-indexed table in the memory. The server also communicates with building-management controllers using a building-automation protocol over IP networks to obtain environmental condition values such as temperature, humidity, and airflow. The server associates each measurement with metadata including device identifier, equipment group identifier, space region identifier, and acquisition time, and stores this information in structured records.

The server acquires external environment data from external information sources via a wide-area network. For example, the server uses a hypertext transfer protocol client library to send requests to an energy-price information service and receives structured responses describing time-of-use energy prices for future time intervals. The server also queries a weather-forecast service to obtain predicted outside temperature, humidity, and wind speed for the facility's location, and queries a regional supply information service to obtain forecasted availability of an energy supply source such as renewable energy. The server stores these external data in tables keyed by time and location.

The server processes internal and external data using a specific data structure and algorithmic flow designed to improve data consistency and computational efficiency. The server loads recent internal and external records into an in-memory tabular representation, where each row corresponds to a discrete time interval and each column corresponds to a measured or derived quantity. The server performs temporal alignment by resampling all data streams to common intervals, such as five-minute or fifteen-minute windows, and assigns a canonical time stamp to each row. In cases where multiple measurements fall within one interval, the server applies aggregation functions such as mean, median, or maximum; in cases where no measurement falls within an interval, the server applies interpolation schemes, such as linear interpolation for continuous values or last-observation-carried-forward for slowly varying states.

The server applies data-quality algorithms to identify and correct abnormal values. For each measurement channel, the server maintains sliding windows of historical values and calculates statistical indicators such as mean and standard deviation. When a new value deviates from the expected range beyond a configurable threshold, the server marks it as abnormal. The server then replaces certain abnormal values using smoothing filters or model-based estimates, or flags them as unusable. By performing this cleaning and alignment, the server generates unified time-series data with reduced noise and missingness, which enables more stable and efficient downstream processing by predictive models and the generative AI model.

The server computes derived indicators from the unified time-series data. For example, the server calculates rolling averages and peak power for each equipment group, total facility power, information-technology power, and derived efficiency metrics such as power-usage-effectiveness. The server also computes temperature gradients between different space regions, such as cold aisles and hot aisles, and evaluates constraints such as maximum allowable temperature for sensitive equipment. These indicators are stored in separate key-performance-indicator tables with references to the underlying time-series records. This structured representation allows the server to reference high-level metrics directly in subsequent optimization and prompt-generation steps without recomputing them, thereby improving processing speed.

The server constructs prompt sentences and associated structured data for a generative AI model using a dedicated prompt-generation module. The server selects a time horizon for optimization, for example twenty-four hours, and extracts from the unified time-series data and indicator tables all relevant entries that fall within that horizon. The server compresses these entries into a concise representation, such as a sequence of time-stamped records containing, for each equipment group and space region, predicted load, current environmental conditions, and applicable external environment data such as energy price and energy supply availability.

The server then generates a prompt sentence in natural language that describes the context, constraints, and optimization objectives for the generative AI model. In one embodiment, the server uses a template containing fixed text segments and placeholder positions for numerical values and lists. The server fills the placeholders with values such as allowable temperature ranges, minimum numbers of active devices per application group, maintenance windows, and target cost thresholds. The server also appends instructions specifying the desired output format, such as a list of time-stamped control actions in a structured layout that is amenable to parsing by the server.

For example, the server may generate the following prompt sentence:

“Using the following forecast and status information for the next 24 hours, propose an hour-by-hour operating schedule for all server racks and cooling zones. For each hour and for each rack, the schedule should specify whether servers remain active, are consolidated, or are placed into a low-power or shutdown state. For each cooling zone, the schedule should specify a target supply-air temperature setpoint. The schedule must satisfy the following constraints: (1) all rack inlet temperatures must remain between 20° C. and 27° C.; (2) each application cluster must keep at least the minimum number of active servers specified; (3) maintenance actions must occur only within the allowed maintenance window. The objective is to minimize total energy cost while keeping service quality within acceptable limits. Please output the schedule as a structured list, grouped by hour, with explicit rack identifiers, cluster identifiers, and cooling zone identifiers.”

In another example, the server may generate a prompt sentence such as:

“Based on the past 60 days of load, power, and temperature data, and the forecasted electricity prices for the next 7 days, estimate the potential cost savings and operational risks of increasing the cold-aisle inlet temperature target by 2° C. Propose a step-by-step implementation plan for the next four weeks, indicating for each week how the temperature targets, server consolidation policy, and cooling setpoints should be adjusted. Explicitly state any conditions under which the plan should be rolled back.”

The server transmits the prompt sentence and the associated structured data to a generative AI model. In one embodiment, the generative AI model is implemented as a transformer-based neural network including multiple layers of self-attention and feed-forward components. The model receives tokens representing the prompt sentence and, optionally, a serialized representation of the structured data. The model uses learned parameters, such as weight matrices in attention heads and feed-forward layers, to compute context-sensitive representations of the input tokens and generate output tokens representing the optimization plan. The model may be trained using supervised fine-tuning on historical examples of facility control plans, or may be combined with reinforcement learning where control outcomes influence future training.

The server configures the generative AI model with parameters such as maximum output length, sampling temperature, and presence-penalty values to balance diversity and determinism of the output. By constraining the output format in the prompt sentence and fine-tuning the model on examples of structured schedules, the server causes the model to produce machine-interpretable schedules rather than free-form text, thereby reducing the need for complex natural-language understanding on the server and improving overall computational reliability and efficiency.

The server parses the optimization plan returned by the generative AI model using a plan-interpretation module. This module is implemented, for example, as a rule-based parser that scans the output for hour markers, device identifiers, action keywords, and numerical parameters such as target temperature or power state. The server aligns parsed actions with internal identifiers of equipment and space regions stored in a configuration database. The server then evaluates each action against safety and operational constraints. For example, if a proposed action would lower a cooling setpoint below a permitted minimum or would deactivate more devices in a cluster than allowed, the server marks the action as violating constraints. The server may adjust such actions by clipping values to allowed ranges or by rejecting the action and logging a violation.

The server generates a validated control plan that contains only actions that satisfy all constraints, or adjusted actions that have been made safe. The server stores the validated plan in the memory, associated with timestamps and device identifiers. The server also records metadata such as which constraints were active and whether any actions required adjustment, for later analysis.

The server converts the validated control plan into concrete control commands suitable for equipment interfaces. For power-related devices such as servers or power-distribution units, the server generates commands compatible with hardware-management protocols that specify operations such as power-down, power-up, low-power mode entry, or power-cap allocation. For environmental control devices such as cooling units or ventilation systems, the server generates messages conforming to building-automation protocols, specifying new setpoints for supply-air temperature, fan speed, or valve positions. The server schedules these commands for execution at specific times, for example using a job scheduler or task queue. The server monitors acknowledgments from devices and, in case of failure or delay, may reissue commands or trigger fall-back actions such as reverting to a safe default profile.

The terminal presents information about current and planned operations to the user. The terminal requests and receives from the server a summary of the validated control plan, recent environmental conditions, and energy-usage metrics. The terminal then renders graphical elements such as time-series charts, Gantt-type schedules, and tables showing which equipment groups will be consolidated or adjusted at specific times. The user views these displays and may change configuration parameters such as allowable temperature ranges, target cost thresholds, or maintenance windows. The terminal sends updated configuration information to the server, which stores it and uses it in subsequent prompt construction and plan verification.

The user may also interactively issue custom prompt sentences to the generative AI model through the server. The terminal provides a text-input area where the user writes requests in natural language. For example, the user may input:

“Generate a detailed weekend maintenance schedule that minimizes energy cost while ensuring that no more than 5% of production servers in any cluster are offline at the same time. Explicitly list which racks and which hours are selected for shutdown.”

The terminal transmits this prompt to the server. The server enriches the prompt with selected data and constraints, forwards it to the generative AI model, and then processes the response through the same parsing and validation procedures described above. The terminal displays the resulting schedule, and the user may approve or reject its application. This interaction allows the user to steer the optimization at a high level while the server performs the complex technical tasks of data integration, prompt construction, plan verification, and command generation.

The server uses historical data to improve its internal logic and thus improve computer-implemented operations over time. The server periodically analyzes logs of unified time-series data, optimization plans, validated control plans, and execution results. The server trains predictive models, such as regression or sequence models, to forecast future load or temperature based on past measurements and external conditions. The server uses a loss function, such as mean-squared error between predicted and actual values, and updates model parameters using gradient-descent-based optimization. The server uses these predictive models to generate more accurate feature values for future horizons, which in turn improves the quality of information supplied to the generative AI model. By doing so, the server reduces prediction error and improves the stability of the optimization process.

In addition, the server updates rule sets used in verification of optimization plans. For example, if the server observes that particular patterns of actions, such as aggressive consolidation in certain space regions, consistently lead to temperature spikes or other adverse conditions, the server modifies constraint parameters or adds new rules to prevent such patterns. The server also refines prompt sentence templates based on observed performance, for instance by adding explicit instructions to prioritize safety constraints or to avoid actions known to be problematic. This adaptation process is automated: the server analyzes discrepancies between predicted and actual outcomes and integrates the findings into prompt templates and verification rules. This iterative refinement leads to improved computational efficiency, reduced number of constraint violations, and faster convergence to stable control policies.

The described architecture improves computer technology in several ways. By using unified time-series data structures and explicit feature-extraction modules, the server reduces redundant computation and enables efficient in-memory processing, leading to faster response times compared with ad-hoc processing of independent data streams. By constructing structured prompt sentences with precise constraints and desired output formats, the server shapes the generative AI model's output so that parsing and validation become deterministic and lightweight, thereby reducing processing overhead and error rates. The closed-loop integration of predictive models, generative AI output, and rule-based verification enables the server to autonomously manage complex energy-optimization tasks at a scale and speed that is not feasible for a human operator employing manual procedures.

The system is not limited to any particular type of facility or equipment. In one embodiment, the controlled facility is a data center with information-processing equipment and cooling infrastructure. In another embodiment, the controlled facility is a commercial building with multiple floors and zones, including lighting, heating, ventilation, and air-conditioning devices.

In yet another embodiment, the system is applied to an industrial plant where production equipment and utility systems are controlled. In each case, the server implements the same fundamental modules for data acquisition, data processing, prompt generation, model execution, plan verification, and device control, but the specific measurement devices, external data sources, and equipment interfaces may vary.

The generative AI model may also be implemented in different ways. In one configuration, the server accesses an external generative AI service over a network. In another configuration, the server hosts one or more generative AI models locally, executed on hardware accelerators such as graphics-processing units or specialized matrix-processing units. The model architecture may be a multi-layer transformer with a specified number of attention heads and hidden-layer dimensions, or a related sequence-to-sequence architecture. The server may maintain multiple models for different purposes, such as one model specialized for schedule generation and another model specialized for explanatory reports, and select an appropriate model based on the type of prompt sentence.

By structuring the system in this way, the server performs specific technical processing that goes beyond simple automation of human tasks. The server implements non-conventional sequences of data preparation, model interaction, and control plan verification that are tailored to the constraints of energy-management equipment and the characteristics of generative AI models.

The causal relationship between these processing steps and the resulting improvements—such as reduced energy cost, more stable environmental conditions, reduced constraint violations, and improved computational efficiency—can be traced through stored data and logs. As a result, the system achieves a technical effect of improved computer-implemented control of physical equipment in the real world, rather than merely executing an abstract business method or generic data analysis.

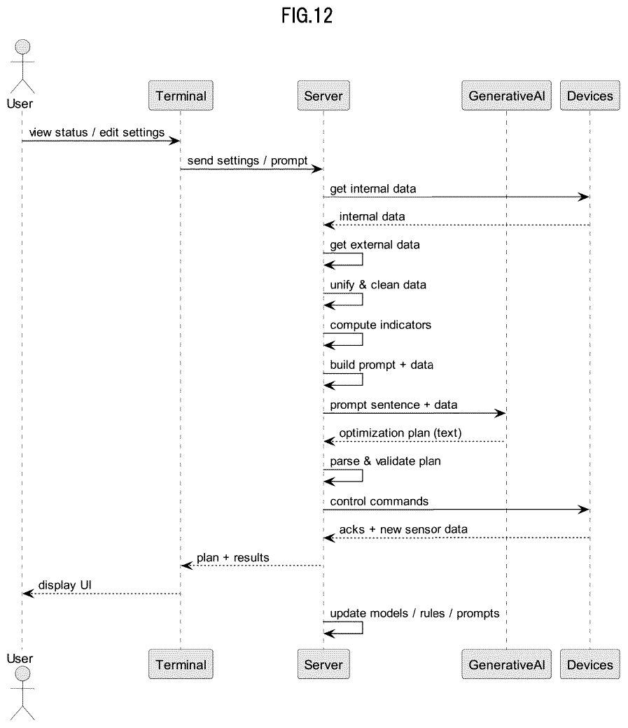

The following describes the processing flow using FIG. 12.

### Step 1:

The server acquires internal measurement data from devices in the controlled facility.

The server receives as input raw sensor and meter readings, including power measurements from power meters, temperature and humidity from environmental sensors, airflow from airflow sensors, and device state information from equipment controllers. The server opens communication sessions over industrial protocols and network sockets, reads register values or sensor payloads, converts encoded values into physical units (for example, watts, degrees Celsius, percentage humidity), and attaches timestamps, equipment group identifiers, and space region identifiers. The server outputs structured internal measurement records and stores them in a time-indexed data structure in memory or a database.

### Step 2:

The server acquires external environment data from external information sources via a network.

The server receives as input responses from external services, including energy price information from an energy-price service, weather forecasts from a weather-information service, and energy supply availability from a supply-status service. The server sends HTTP requests with query parameters such as facility location and time range, parses response payloads, extracts fields such as hourly price, forecasted temperature, and renewable-share percentage, and normalizes units and time zones. The server outputs external environment records with unified timestamps and metadata, and inserts them into dedicated database tables keyed by time and location.

### Step 3:

The server generates unified time-series data by synchronizing and cleaning internal and external data.

The server receives as input the internal measurement records and external environment records stored in the database. The server uses a data-processing module to resample all data streams to common time intervals, for example every five minutes or fifteen minutes, by grouping raw records into time buckets based on their timestamps. The server computes interpolation or aggregation for each bucket: for internal data, the server may calculate average power, minimum and maximum temperature, and last-known device state; for external data, the server may align to the nearest forecast point. The server detects missing values and outliers using statistical thresholds relative to moving means and standard deviations. For detected anomalies, the server either replaces values with interpolated estimates or flags them as invalid and excludes them from derived metrics. The server outputs unified time-series records, where each record corresponds to a time interval and includes synchronized internal and external values.

### Step 4:

The server computes aggregated indicators and derived indicators from the unified time-series data.

The server receives as input the unified time-series records. For each equipment group and each space region, the server groups time-series entries according to identifiers and time windows, such as one-hour or one-day windows. Within each group, the server performs data aggregation operations, including calculating average power, peak power, total energy consumption, average temperature, maximum temperature, and airflow statistics. The server then computes derived indicators, such as power-usage-effectiveness by dividing total facility power by total information-technology power, and temperature gradients by subtracting average cold-aisle temperature from average hot-aisle temperature. The server outputs a set of indicator records, where each record includes an equipment group or space region identifier, a time window, and the associated aggregated and derived indicator values.

### Step 5:

The server collects constraint information and optimization objectives to form an optimization context.

The server receives as input configuration data stored in a configuration repository and, optionally, user-provided settings received from the terminal. The server reads parameters such as allowable temperature ranges, maximum and minimum numbers of active devices per application group, maintenance windows, and target energy-cost thresholds. The server also checks maintenance and outage tables to identify devices eligible for shutdown or maintenance in the planning horizon. Based on these inputs, the server constructs an optimization context object, including constraint parameters, allowed device states, and objective weights such as cost minimization versus service-quality preservation. The server outputs the optimization context as a structured configuration set that can be referenced in prompt generation.

### Step 6:

The server constructs a prompt sentence and associated structured data for a generative AI model.

The server receives as input the unified time-series records, the indicator records, and the optimization context. The server selects a planning horizon, for example the next twenty-four hours, and extracts the subset of time-series and indicator data that falls within that horizon. The server converts these data into a compact structured representation, such as a list of time-stamped entries for each equipment group and space region, containing predicted load, current temperature, humidity, airflow, energy price, and energy supply availability. The server then applies a prompt-template function that inserts numerical values, time ranges, and constraint descriptions into predetermined positions within a natural-language structure. As a result, the server generates a prompt sentence that explains the situation, states constraints and objectives, and requests a specific output format. The server outputs the final prompt sentence as text and the associated structured data as a machine-processable attachment linked to the prompt.

### Step 7:

The server invokes the generative AI model using the prompt sentence and associated structured data.

The server receives as input the text prompt and the associated structured data generated in Step 6. The server encodes these inputs into a request message conforming to a model-access interface, which may be a local inference endpoint or a remote API. The server sets model parameters such as maximum token count, sampling temperature, and a directive to output a structured schedule. The server transmits the request to the generative AI model, which processes the prompt token by token using its internal transformer architecture and produces a sequence of output tokens representing an optimization plan. The server receives the generated optimization plan as text from the generative AI model and stores the raw output for subsequent parsing. The server outputs the raw optimization-plan text as the result of the model invocation.

### Step 8:

The server parses the optimization plan and extracts candidate control actions.

The server receives as input the raw optimization-plan text returned by the generative AI model.

The server executes a parsing procedure that scans the text for structural markers such as time headers, equipment group identifiers, space region identifiers, and action keywords like “power down,” “consolidate,” “increase setpoint,” and “decrease setpoint.” The server uses predefined parsing rules and patterns to segment the text into atomic control actions, each action including a timestamp or time interval, a target device or group, and a parameter value such as target temperature or power state. The server normalizes identifiers to internal device IDs and converts textual descriptions of times and states into canonical representations. The server outputs a list of candidate control-action records that can be evaluated against constraints.

### Step 9:

The server validates the candidate control actions against safety and operational constraints.

The server receives as input the list of candidate control-action records and the optimization context including constraints. For each action, the server computes predicted impacts using the current state and, where available, predictive models, such as whether a proposed temperature setpoint would cause any rack inlet temperature to exceed a maximum or fall below a minimum.

The server compares proposed active-device counts per application group with minimum and maximum limits, and checks that proposed maintenance times fall within approved maintenance windows. If an action violates a constraint, the server either adjusts parameters to the nearest allowed value, such as clipping a setpoint to an upper limit, or marks the action as invalid and discards it. The server records the reason for modification or rejection in a log. The server outputs a validated control-plan list consisting of approved and possibly adjusted control actions that comply with all applicable constraints.

### Step 10:

The server generates low-level control commands from the validated control plan.

The server receives as input the validated control-plan list. For each validated control action, the server maps logical identifiers to specific device interfaces, such as network addresses of servers, power-distribution units, or control endpoints of environmental devices. The server constructs protocol-specific messages, for example messages for hardware-management interfaces to change server power states, or messages for building-automation protocols to modify cooling-unit temperature setpoints. The server assigns execution times to each command based on the scheduled time or time interval in the control action. The server then enqueues the commands into a scheduler or job queue for timed dispatch. The server outputs a command schedule, which specifies for each command the target interface, payload, and execution time.

### Step 11:

The server executes control commands and monitors real-time responses.

The server receives as input the command schedule. At each execution time, the server sends the corresponding control command over the appropriate interface to the target device. The server waits for acknowledgments or status responses and records success or failure statuses. In parallel, the server continues to collect internal measurement data, including updated power, temperature, and airflow values, as in Step 1. The server compares the observed measurements after command execution with expected trends, for example checking whether power consumption in a group decreases after a shutdown action or whether temperature follows the adjusted setpoint. If the server detects a deviation beyond a threshold, the server may generate corrective actions, such as restoring a previous state or increasing cooling temporarily. The server outputs updated state information and performance metrics that reflect the actual effect of the control commands.

### Step 12:

The terminal displays optimization results and receives updated configuration or prompt sentences from the user.

The terminal receives as input summary data and plan information from the server, including the validated control plan, execution status, and current measurements and indicators. The terminal renders visual elements, such as charts of power usage, tables of scheduled device operations, and alerts about constraint-related adjustments. The user views these displays and may enter configuration changes, such as updated temperature limits or new cost-reduction priorities, using forms or sliders. The user may also input a free-form prompt sentence addressed to the generative AI model, such as “Generate a weekly maintenance plan that minimizes energy cost while keeping at least 95 percent of production capacity online at all times.” The terminal sends the updated configuration and the user prompt to the server in structured messages. The terminal outputs user-provided parameters and prompt sentences as input to the server for subsequent optimization cycles.

### Step 13:

The server updates internal models, rule sets, and prompt templates based on historical data.

The server receives as input historical unified time-series data, past optimization plans, validated control plans, and execution results stored over time. The server performs analysis using statistical and machine-learning algorithms to quantify how closely predicted outcomes matched actual measurements and how effectively past plans reduced energy cost or maintained environmental stability. The server computes error metrics such as mean-squared error for predictions and counts of constraint violations for plans. Based on these analyses, the server adjusts parameters of predictive models using weight-update algorithms, revises rule sets for validation by adding or tightening rules for problematic patterns, and modifies prompt templates to emphasize constraints or output formats that have produced better results. The server outputs updated model parameters, revised rules, and new versions of prompt templates, which are then used as input in future executions of Steps 5 through 9, thereby improving accuracy, robustness, and computational efficiency over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional smart home energy management systems typically optimize energy usage based only on physical and economic parameters such as indoor temperature, humidity, device power consumption, weather forecasts, and time-of-use electricity prices. These systems often implement relatively simple rule-based or threshold-based control logic running on general-purpose computing hardware. As a result, the underlying computer processes are limited to straightforward data collection, static aggregation, and direct mapping from sensed values to control outputs. Such architectures do not fully exploit advanced machine-learning or generative AI capabilities and therefore do not provide a technically efficient way to integrate heterogeneous real-time sensor data, user feedback, and external information into a unified optimization pipeline.

In particular, existing systems suffer from at least the following technical problems in the computing processes themselves. First, data ingestion pipelines are not designed to robustly integrate multi-modal data streams including environmental sensor data, device state data, subjective user input, biometric signals, and external data such as weather and tariffs on a common time axis. This leads to frequent inconsistencies, missing alignments, and computational overhead in downstream processing. Second, emotion or comfort estimation, when present at all, is often implemented as simple mapping tables or thresholds rather than as machine-learning models operating on properly constructed feature vectors. This limits the ability of the computer system to infer latent user states in a scalable, automated manner and prevents effective reuse of the same infrastructure for many users and buildings.

Third, conventional energy planning logic does not leverage a generative AI model in a way that is systematically integrated with the rest of the data pipeline. Even when a generative AI model is used, prompt sentences are often constructed in an ad hoc manner without precise encoding of time-series summaries, user-specific preference patterns, or multi-objective optimization goals. Consequently, the computational behavior of the generative AI model is suboptimal, and it becomes difficult for the computer system to reliably translate raw sensor and feedback data into concrete, physically constrained control parameters. Fourth, validation and constraint checking of the AI-generated plans is frequently absent or handled manually, which can cause the computer system to output control commands that violate device constraints or contractual limits, thereby reducing robustness and requiring human intervention.

Furthermore, user feedback is not effectively integrated into a closed computational loop that updates both emotion estimation models and prompt-generation logic. Existing systems typically treat user evaluations as optional annotations rather than as structured training signals. As a result, the underlying computing system does not improve its internal models or prompt structures over time, and cannot efficiently adapt its computational behavior to the individual user's comfort patterns without extensive manual reconfiguration.

Accordingly, there is a need for an improved computer-implemented smart home control system that: (i) programmatically integrates heterogeneous time-series data on the server side into unified emotion-related datasets; (ii) automatically estimates user emotion states using a trained machine-learning model; (iii) constructs structured prompt sentences for a generative AI model that encode time-series summaries, optimization targets, and learned user preferences; (iv) parses and validates AI-generated text plans into structured control parameters under device and system constraints; and (v) closes the loop by feeding user feedback back into the emotion estimation and prompt-generation components. Such a system should improve the efficiency, robustness, and adaptability of the underlying computer processes themselves, rather than merely automating known manual procedures.

The specific processing by the specific processing unit 290 of the data processing device 12 in Example 2 is realized by the following means.

The present invention provides a server comprising a processor and a memory storing instructions which, when executed by the processor, cause the processor to acquire energy usage information and environmental state information from detection devices and apparatuses installed in a building, to organize the energy usage information and the environmental state information as time-series data based on time information, to perform preprocessing including at least unit conversion, missing-value completion, outlier correction, and smoothing to generate state-information tables, and to receive subjective input information from a user terminal and biological information from a wearable apparatus, to calculate statistical values of the biological information for each predetermined time window to generate vital-feature data, and to integrate the subjective input information and the vital-feature data with the state-information tables on a common time axis to create integrated emotion-related datasets for each user; to acquire external information including weather information and time-of-use electricity price information from an external information-providing apparatus via a communication network and to store such external information as external-information tables keyed by at least time and region; to generate feature vectors representing indoor environmental states, apparatus states, subjective input states, and biological states based on the integrated emotion-related datasets and the external-information tables, to input the feature vectors to a trained machine-learning model to estimate, for each user, an emotion state including at least a comfort index, a stress index, and an emotion category, and to store emotion-state data associated with time information and user identification information; to acquire, for a predetermined period, energy usage information, environmental state information, external information, and the emotion-state data, to compute numerical summaries and explanatory text describing, for each time period, at least energy consumption, indoor environmental state, electricity price, and emotion indices, and to generate a structured prompt sentence that describes instructions and premises to be provided to a generative AI model, the prompt sentence explicitly including optimization targets comprising at least suppression of energy costs and maintenance of a user comfort index above a predetermined threshold and including user-specific preference patterns and a desired control mode; to input the prompt sentence to the generative AI model, to obtain text data representing an energy-usage optimization plan that specifies, for each time period in the predetermined period, at least an air-conditioning setting temperature, a lighting output level, an operation schedule for household apparatuses, and a charge-and-discharge plan for a storage apparatus, and to parse the text data to generate a structured set of control parameters for each apparatus and each time period; to verify the set of control parameters against constraint conditions including at least permissible temperature ranges, lighting output ranges, appliance operation windows, and storage apparatus input-and-output limits, to correct the set of control parameters to satisfy the constraint conditions to generate a final control plan, and to transmit the final control plan to a terminal for execution; and to receive user evaluations and free-form feedback, to store such evaluations and feedback in association with the corresponding indoor environmental states, control conditions, and emotion-state data, to extract user-preference pattern information therefrom, and to update at least one of parameters or correction rules of the machine-learning model and a prompt-generation logic for the prompt sentence based on the user-preference pattern information. This enables the underlying computer system to more efficiently and reliably process heterogeneous time-series data, to generate and refine emotion-aware energy optimization plans using a generative AI model under explicit constraints, and to automatically adapt model behavior and prompt structures over time in response to user feedback, thereby improving the technical performance, robustness, and personalization capability of smart home control operations.

The term “energy usage information” refers to information indicating amounts and temporal variations of consumed energy, including at least electrical energy, thermal energy, or gas usage by one or more apparatuses or systems installed in a building.

The term “environmental state information” refers to information indicating physical environmental conditions in or around a building, including at least temperature, humidity, illuminance, and optionally other measurable environmental parameters.

The term “detection device” refers to any sensing device or metering device configured to generate measurement data related to energy usage or environmental state, including at least power meters, gas meters, temperature sensors, humidity sensors, and illuminance sensors.

The term “apparatus” refers to any controllable device installed in a building that consumes or manages energy, including at least an air-conditioning apparatus, a lighting apparatus, a household apparatus, and a storage apparatus.

The term “time-series data” refers to data represented as sequences of values each associated with time information, such as timestamps or time intervals, and ordered in chronological order.

The term “state-information table” refers to a structured data collection, such as a database table or equivalent data structure, in which rows represent time-indexed records of environmental or apparatus states and columns represent measured or derived attributes.

The term “preprocessing” refers to a set of data manipulation operations applied to raw or partially processed data, including at least unit conversion, missing-value completion, outlier correction, and smoothing or filtering for noise reduction.

The term “subjective input information” refers to information explicitly input by a user through a user interface to express perceived comfort, thermal sensation, activity state, or desired control mode.

The term “biological information” refers to information indicating physiological or biometric states of a user, including at least heart rate, heart rate variability, body movement, and sleep-related parameters.

The term “vital-feature data” refers to derived data including statistical values or aggregated measures computed from biological information over predetermined time windows, such as averages, variances, or frequency-domain indices.

The term “integrated emotion-related dataset” refers to a dataset obtained by aligning and combining environmental state information, apparatus state information, subjective input information, and vital-feature data on a common time axis for a particular user.

The term “external information” refers to information obtained from an information-providing system outside the building, including at least weather information and time-of-use electricity price information.

The term “external-information table” refers to a structured data collection in which rows represent time-indexed external information records and columns represent attributes such as forecasted weather parameters and electricity prices, associated with at least time and region identifiers.

The term “feature vector” refers to a numerical vector comprising multiple components that encode one or more aspects of indoor environmental states, apparatus states, subjective input states, and biological states for use as an input to a machine-learning model.

The term “machine-learning model” refers to a computational model, such as a neural network or other statistical learning model, that has been trained on example data to approximate a mapping from feature vectors to target outputs, such as emotion state indicators.

The term “emotion state” refers to an estimated psychological or affective condition of a user, including at least a comfort index, a stress index, and a categorical emotion label such as relaxed, stressed, or sleepy.

The term “emotion-state data” refers to stored data representing estimated emotion states of users, each associated with at least time information and user identification information.

The term “time-of-use electricity price information” refers to information indicating unit prices of electrical energy for multiple discrete time periods, where the price varies depending on the time of day or other scheduling rules.

The term “prompt sentence” refers to a structured natural-language or quasi-natural-language text that describes instructions, premises, data summaries, optimization targets, and user preferences to be provided as input to a generative AI model.

The term “generative AI model” refers to an artificial intelligence model configured to generate new text, structured data, or other content in response to an input prompt, and including at least a large language model that performs inference over sequences of tokens.

The term “energy-usage optimization plan” refers to a plan specifying, for a predetermined period and for each time segment, desired operating conditions of one or more apparatuses so as to achieve one or more optimization goals related to energy cost and user comfort.

The term “control parameter” refers to a value or set of values that define operating conditions for an apparatus, such as a target temperature, a lighting brightness level, an operation start time, or a charge-and-discharge power level.

The term “constraint condition” refers to a rule or limit that restricts allowable values of control parameters, including physical constraints of apparatuses, contractual limits, and policy-based restrictions on operation times or intensities.

The term “final control plan” refers to a set of control parameters for one or more apparatuses over a predetermined period that have been adjusted to satisfy all applicable constraint conditions.

The term “user feedback” refers to information indicating a user's evaluation or impression of an environmental or control condition, including at least a comfort or discomfort rating and optionally free-form text comments.

The term “user-preference pattern information” refers to information derived from user feedback and associated data that characterizes one or more ranges or combinations of conditions, such as temperature and illuminance, that tend to be evaluated as comfortable or uncomfortable by the user.

The term “prompt-generation logic” refers to processing rules, templates, or algorithms used to construct a prompt sentence for the generative AI model from input data including summaries, optimization targets, and user-preference pattern information.

The term “air-conditioning apparatus” refers to an apparatus that regulates indoor air temperature, humidity, and airflow by performing at least cooling, heating, or dehumidifying operations.

The term “lighting apparatus” refers to an apparatus that emits light and that is controllable with respect to at least output level, on/off state, or color-related properties.

The term “household apparatus” refers to any energy-consuming appliance used in a residence or building, such as a washing machine, dishwasher, refrigeration appliance, or audiovisual device, that can be controlled or scheduled by an external control signal.

The term “storage apparatus” refers to an energy storage device, such as an electrical storage device, that can store energy during a charge operation and provide energy during a discharge operation under control of external commands.

The term “charge-and-discharge plan” refers to a schedule or specification defining, for each time period in a predetermined horizon, whether a storage apparatus is to perform charging or discharging and at what power or energy levels.

In one or more embodiments, the system includes a terminal installed in or near a building, a server implemented on one or more computing devices in a data center or cloud environment, and a user terminal such as a smartphone or tablet. The terminal, the server, and the user terminal are interconnected via one or more communication networks.

Server executes one or more software modules on at least one general-purpose processor under an operating system such as a Unix-like operating system. Server uses a container execution environment, for example a container engine, to host an application stack including a web service layer, a data storage layer, and a machine-learning layer. Server executes application logic implemented, for example, in a high-level programming language such as Python together with numerical libraries such as NumPy and a machine-learning framework such as TensorFlow or PyTorch. Server accesses a relational database management system, such as an SQL-compliant database engine, to store and retrieve time-series records and model results.

Terminal includes one or more processors, a main memory, a non-volatile storage device, and network interfaces supporting wired and wireless communication (for example, Ethernet, Wi-Fi, ZigBee, Bluetooth, or other low-power wireless protocols). Terminal runs an operating system such as a Unix-like operating system and executes gateway software components implemented in, for example, Python and a JavaScript runtime. Terminal connects to in-building meters, sensors, and controllable appliances and acts as a data concentration and control execution node. User uses the user terminal to provide subjective information and feedback and to monitor the system. User interacts with a native or web-based application executing on a mobile operating system and accesses the server via secure HTTP connections.

In one embodiment, terminal acquires measurement data from a plurality of detection devices and apparatuses. Terminal communicates with smart power meters and gas meters via protocols such as ZigBee or other fieldbus interfaces. Terminal uses a sensor bus interface such as an FC bus to acquire readings from environmental sensors, including temperature sensors, humidity sensors, and illuminance sensors. Terminal converts raw sensor values to physical units using calibration parameters stored in memory. Terminal also communicates with controllable apparatuses such as air-conditioning apparatuses, lighting apparatuses, and household apparatuses via HTTP-based APIs, message-oriented middleware, or proprietary control interfaces.

Terminal stores acquired values as time-stamped records in a local storage module, which may be implemented as a file-based time-series log or an embedded database. Terminal normalizes data by performing unit conversions and by rounding values to predetermined numeric precision.

Terminal applies a smoothing filter, such as a moving average filter over a fixed window size, to reduce noise in high-frequency measurements. Terminal marks and corrects outliers using a statistical rule (for example, rejecting values outside a certain multiple of a rolling standard deviation) and interpolates missing values for short gaps. Terminal thereby generates state-information tables in which each row includes a timestamp, a device or location identifier, and normalized measurement values.

Server receives batched state-information tables from the terminal. Server validates incoming data packets by comparing schema versions and verifying field presence and ranges. Server writes validated records into persistent data structures, such as normalized tables for environmental state information and apparatus state information. Server maintains indexes on time and device identifiers, thereby reducing query time for subsequent feature construction.

User uses the user terminal to input subjective information including comfort evaluations, thermal sensations, activity states, and desired modes. User manipulates user interface components such as sliders and buttons to select values. User submits the inputs, and the user terminal formats them as structured messages, which include user identifiers and timestamps.

Server or terminal receives the messages, translates symbolic labels into numeric codes, and stores them as subjective input information associated with corresponding time stamps.

User optionally wears a wearable device that generates biological information such as heart rate, heart rate variability, motion data, and sleep phases. User pairs the wearable device with the user terminal, which collects raw biological information via vendor-supplied APIs. The user terminal aggregates these signals and forwards them to the terminal or the server.

Terminal aggregates biological information into vital-feature data. Terminal divides time into fixed windows, such as five-minute or fifteen-minute intervals, and computes statistical values, such as mean heart rate per window, standard deviation of heart rate, mean heart rate variability, total steps per window, and ratios of time spent in different sleep stages. Terminal stores the resulting vital-feature data in local storage and sends it in batches to the server together with environmental and apparatus state data and subjective input information.

Server constructs integrated emotion-related datasets by aligning environmental state information, apparatus state information, subjective input information, and vital-feature data on a common time axis for each user. Server executes alignment by joining records based on timestamps, using nearest-neighbor matching within a predetermined tolerance window. Server encodes categorical fields, such as activity state or thermal sensation, into numerical feature vectors using schemes such as one-hot encoding. Server thereby creates feature vectors in which each component corresponds to a normalized measurement, a coded subjective attribute, or an aggregated biological measure.

Server uses these feature vectors as inputs to a trained machine-learning model that estimates emotion states. In one embodiment, server uses a neural network that includes an input layer matching the dimension of the feature vector, one or more hidden layers, and an output layer that outputs a comfort index, a stress index, and one or more emotion class scores. The hidden layers may be fully connected layers, recurrent layers, or temporal convolution layers. For example, server may implement a feed-forward network with rectified linear unit activations or a recurrent architecture such as a gated recurrent unit that processes sequences of time-ordered feature vectors. Server stores learned weights and biases in a model parameter store.

Server trains the machine-learning model offline before deployment using historical labeled data. Server defines a loss function, such as a combination of mean squared error for continuous indices and cross-entropy for categorical labels, and adjusts model parameters using an optimization algorithm such as stochastic gradient descent or an adaptive gradient algorithm. Server may perform data augmentation by artificially varying certain features within realistic bounds to increase robustness. After training, server serializes the model and loads it into memory to perform inference on new feature vectors.

Server executes inference by passing the feature vectors through the neural network to obtain raw outputs. Server applies post-processing functions, such as sigmoidal transformations or softmax normalization, to generate a comfort index and a stress index in a normalized range and to determine the most likely emotion category. Server stores emotion-state data in the database, associating each estimated state with a user identifier and a timestamp.

Server also acquires external information relevant to energy usage. Server periodically sends queries to external data providers to obtain weather forecasts, including predicted temperatures, humidity, and solar radiation, and to obtain time-of-use electricity prices for future time windows. Server parses responses, converts units, and aligns time stamps with the internal time representation. Server stores external information in external-information tables indexed by time and geographic region.

Server builds summary representations of the data to be supplied to a generative AI model.

Server selects a predetermined planning period, for example twenty-four hours or six hours, and constructs summaries of energy usage, environmental conditions, external information, and emotion-state data for that period. Server groups data by time slot, such as one hour, and computes derived features, including average appliance power consumption per time slot, average indoor temperature and humidity per time slot, average comfort and stress indices per time slot, and average or marginal electricity prices per time slot. Server may also compute derived features, such as peak usage in expensive tariff periods or correlation between environmental conditions and comfort index.

Server converts these numerical summaries into textual descriptions and structured numeric lists.

Server then constructs a prompt sentence as a structured text. In one embodiment, the prompt sentence includes: (1) a role description instructing the generative AI model to act as a smart home energy optimization assistant; (2) a description of the optimization goals, including minimization of energy cost and maintenance of comfort indices above a given threshold; (3) summaries of historical energy use, environmental conditions, and emotion states; (4) forecasts for weather and electricity prices; and (5) user preference patterns derived from prior feedback.

For example, server may generate the following prompt sentence:

“You are a smart home energy optimization assistant.

Based on the following data, propose an energy usage plan for the next 24 hours.

As constraints, minimize the total electricity cost while keeping the user's average comfort score at or above 0.7.

1. Hourly power consumption (kWh) of the air conditioner, lighting, washing machine, and dishwasher during the past 24 hours.

2. Weather forecast for the next 24 hours (temperature, humidity, solar radiation).

3. Time-of-use electricity tariffs for the next 24 hours (currency/kWh).

4. Time series of the user's comfort score and stress level estimated by the emotion engine during the past 24 hours.

5. User's desired mode: ‘Balanced (trade-off between energy saving and comfort)’.

Output format: for each 1-hour time slot, provide:
Air conditioner setpoint temperature (° C.)
Target lighting brightness level (%)
Start times for the washing machine and dishwasher
Battery charging/discharging plan

Return the plan as clear text that can be parsed into a schedule.”

In another example, server may generate a prompt sentence focused on short-term comfort adjustment:

“The current time is 21:00.

The current room temperature is 27° C., humidity is 60%, the user's comfort score is 0.4, and the stress level is 0.8.

The user has requested ‘I want to relax’.

The weather forecast and electricity tariffs for the next 6 hours are as follows: [omitted for brevity].

Based on this information, propose an air-conditioner and lighting control plan for the next 6 hours that:
Improves the comfort score to 0.8 or higher, and
Reduces air-conditioner load during high-price tariff periods.

Output format: for each hour, list ‘setpoint temperature’ and ‘lighting brightness (%)’.”

In a further example, server includes user preference patterns in the prompt sentence:

“During the past week, the user evaluated the following conditions as ‘comfortable’:
Room temperature 24-25° C.
Lighting brightness 30-40%

The user evaluated the following conditions as ‘uncomfortable’:
Room temperature above 27° C.
Lighting brightness below 20%

Using this preference information, generate a 24-hour control plan that prioritizes temperature and brightness conditions with high comfort probability while reducing total electricity cost.

Include hourly air conditioner setpoints, lighting brightness levels, and suggested operation times for major appliances.”

Server provides the prompt sentence to a generative AI model. In one embodiment, the generative AI model is a large language model that processes tokenized sequences using a transformer architecture. Such a model includes multiple attention layers, feed-forward sublayers, and layer normalization operations. Server hosts the generative AI model locally or accesses it via an application programming interface exposed by an inference service. Server specifies input and output parameters, such as maximum token length and temperature parameters for sampling processes.

Server receives text output from the generative AI model. The output includes natural-language descriptions of recommended actions for each time slot. Server parses the text using a deterministic parsing algorithm that searches for time slot headers and associated numerical values. Server validates numerical fields and converts them to internal formats, such as degrees Celsius for setpoint temperatures and percentages for lighting brightness. Server constructs structured control parameters, storing them as records where each record includes a timestamp or time range, a device or device group identifier, and one or more numeric parameters.

Server verifies the structured control parameters against constraint conditions. Server retrieves configuration data specifying constraints, such as minimum and maximum allowable temperatures for each air-conditioning apparatus, minimum and maximum lighting brightness levels, allowed operation windows for household apparatuses, and power and state-of-charge limits for storage apparatuses. Server applies constraint checks, such as clamping values to permissible ranges and rescheduling appliance operation times to avoid prohibited periods. Server also enforces system-level constraints, such as maximum aggregated power draw during peak tariff periods. Server thereby generates a final control plan that satisfies all applicable constraints.

Server transmits the final control plan to the terminal. Terminal receives the plan and stores it in a local schedule. Terminal organizes control actions per time slot and per device. Terminal uses a scheduler component to activate control actions at the correct times. Terminal generates device-specific control messages, such as HTTP commands to device APIs or messages to message queues, and transmits them through network interfaces. Terminal handles response codes and logs outcomes, including any errors, for later analysis by the server.

User experiences changes in indoor conditions resulting from the control plan and provides feedback using the user terminal. User may indicate whether a given condition was comfortable or uncomfortable and may provide additional comments. Server stores such feedback and associates it with the relevant environmental data, control parameters, and emotion-state data at the time of feedback. Server analyzes these records to derive user-preference pattern information, for example by identifying ranges of temperature and brightness that frequently correspond to positive comfort evaluations. Server updates internal preference models and adjusts prompt-generation logic so that future prompt sentences better reflect user-specific preferences.

Server may also perform fine-tuning of the emotion estimation model, for example by adding new labeled data and performing incremental training steps.

This architecture improves computer technology in multiple ways. Server reduces computation required for downstream processing by organizing heterogeneous sensor, subjective, and biological data into unified emotion-related datasets with consistent time alignment and normalized formats. This reduces the complexity of feature-construction logic when compared to systems that repeatedly reconcile disparate data sources on demand. The use of a trained machine-learning model with explicit feature vectors and defined architectures improves the precision of emotion estimation and enables the server to handle high-dimensional, multi-modal time-series data more efficiently than rule-based or manually tuned systems.

By constructing structured prompt sentences that encode time-series summaries, optimization targets, and user-preference patterns, server transforms raw data into an intermediate representation that is better suited for generative optimization. This representation is not a mere presentation of data but a carefully designed data structure articulated in natural language that substantially influences the behavior of the generative AI model. The closed loop of parsing, validating, and constraining AI-generated text into structured control parameters improves reliability and ensures that the output is directly usable by the terminal for apparatus control. This allows the entire system to automatically derive feasible control actions from complex, heterogeneous inputs, which would be impractical to achieve manually at the same temporal resolution.

Furthermore, by feeding user feedback back into the emotion estimation and prompt-generation components, server adapts its internal models and prompts over time, improving prediction accuracy, personalization, and robustness. Because server updates model parameters and prompt-generation rules based on objective error measures and user-labeled data, rather than simply automating a fixed human rule set, the system achieves improved technical behavior, including reduced error rates in comfort prediction, improved convergence of optimization choices, and more efficient allocation of computational resources by limiting unnecessary recomputation. The described data structures, feature engineering, model training methods, and generative AI integration therefore provide specific improvements to the functioning of the computer system itself and enable technically advantageous control of physical apparatuses in a building.

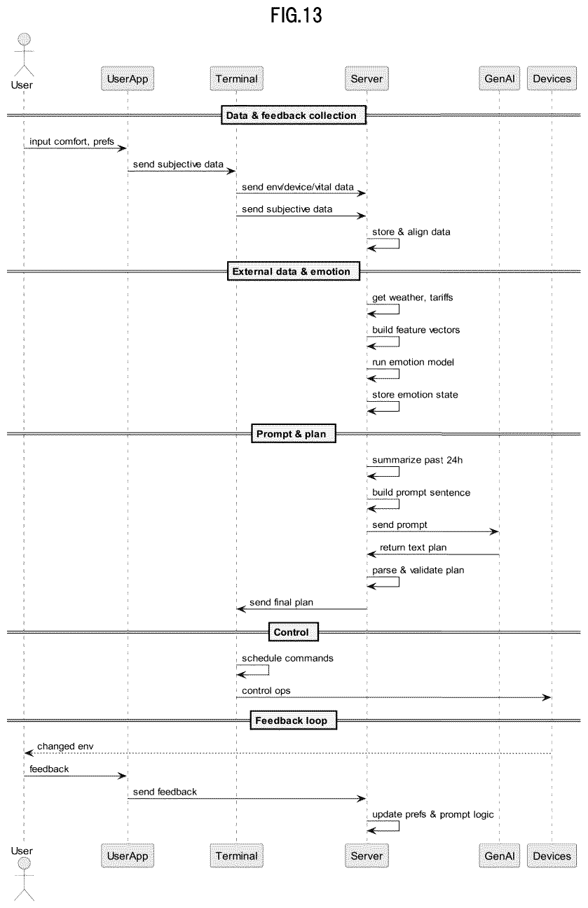

The following describes the processing flow using FIG. 13.

### Step 1:

Terminal acquires raw measurement data from in-building devices.

Terminal receives, as input, raw frames from power meters, gas meters, environmental sensors (temperature, humidity, illuminance), and controllable apparatuses (air-conditioning apparatuses, lighting apparatuses, household apparatuses). Terminal parses protocol-specific frames (for example, ZigBee or PC packets), performs checksum verification, and converts encoded values (for example, hexadecimal or ADC counts) into physical units such as watts, degrees Celsius, percent relative humidity, and lux. Terminal attaches timestamps based on its system clock and associates each measurement with a device identifier. Terminal outputs normalized raw records, each record including at least a timestamp, a device identifier, and one or more numeric measurement values.

### Step 2:

Terminal preprocesses and structures time-series data.

Terminal receives, as input, the normalized raw records from Step 1. Terminal groups records into fixed time intervals (for example, one-minute or five-minute slots) using time-based bucketing. Terminal performs data operations including unit conversion to internal canonical units, interpolation to fill short missing intervals, and outlier detection using statistical thresholds (for example, values exceeding a multiple of a rolling standard deviation). Terminal applies a moving-average filter over each time series to reduce high-frequency noise. Terminal outputs environment state tables and apparatus state tables, in which each row corresponds to a time slot and each column corresponds to a processed variable such as average temperature, average illuminance, and average power consumption per apparatus.

### Step 3:

User provides subjective input via a user terminal.

User receives, as input, current environmental sensations and preferences, such as how hot or cold the user feels and whether the user wishes to prioritize comfort or energy saving. User manipulates graphical user interface elements (sliders, radio buttons, and text fields) to select a comfort score, thermal sensation labels, activity state, and desired control mode. User submits the selections, and the user terminal packages them into a structured message including user identifier and timestamp. User outputs subjective input information that expresses the user's perception and preference in a machine-readable form.

### Step 4:

Terminal or server stores and encodes subjective input information.

Terminal (or server) receives, as input, the structured subjective input information from the user terminal. Terminal validates mandatory fields (user identifier, timestamp, comfort score, selected labels) and rejects malformed messages. Terminal converts textual labels such as “hot”, “cold”, “sleepy”, or “want to relax” into numeric codes or one-hot vectors according to predefined mapping tables. Terminal associates each subjective input record with the nearest environment and apparatus state records based on timestamps. Terminal outputs encoded subjective input records, stored in a local or remote table, which can be joined with time-series data by user and time.

### Step 5:

User provides biological information via a wearable device.

User wears a wearable device that generates raw biological information, such as heart rate, heart rate variability, step count, and sleep phase data, over time. User links the wearable device to the user terminal, which receives the biological information via a vendor-specific API or Bluetooth connection. User indirectly provides, as output, streams of biological information annotated with timestamps and user identifiers, which are forwarded to the terminal or server.

### Step 6:

Terminal aggregates biological information into vital-feature data.

Terminal receives, as input, time-stamped biological information records from the user terminal or directly from the wearable device. Terminal partitions the time axis into predetermined windows (for example, five-minute or fifteen-minute intervals) and groups biological records by user and time window. Terminal computes, for each window, statistical metrics, such as mean heart rate, standard deviation of heart rate, mean heart rate variability, total steps, and proportions of different sleep stages. Terminal outputs vital-feature tables in which each row represents a user-window combination and each column represents an aggregated biological feature.

### Step 7:

Terminal bundles local data into integrated packets and transmits them to server.

Terminal receives, as input, environment state tables, apparatus state tables, encoded subjective input records, and vital-feature tables generated in previous steps. Terminal selects records that have not yet been transmitted to the server and groups them into batches, for example based on time range or record count. Terminal serializes each batch into a structured message (for example, JSON) that contains separate sections for environment data, apparatus data, subjective input data, and vital-feature data, along with metadata such as building identifier, terminal identifier, and schema version. Terminal optionally signs or encrypts the message and sends it over a secure channel (for example, HTTPS or MQTT over TLS) to the server. Terminal outputs integrated data packets suitable for server-side ingestion.

### Step 8:

Server ingests integrated data packets and stores them in persistent tables.

Server receives, as input, the integrated data packets from terminals. Server validates each packet against a predefined schema, verifies that timestamps fall within plausible ranges, and checks that numeric values are within expected bounds. Server then decomposes the packet into component sections, such as environment data, apparatus data, subjective input data, and vital-feature data, and maps each section to corresponding database tables. Server performs insert or upsert operations using a relational database management system, associating each record with building, terminal, and user identifiers as applicable. Server outputs normalized and indexed tables that hold time-series and user-centric data ready for analysis and model processing.

### Step 9:

Server acquires external information and aligns it with internal time scales.

Server receives, as input, responses from external information providers, such as weather forecast services and electricity price services. Server issues periodic HTTP or similar requests, retrieves structured responses (for example, JSON), and extracts fields including forecasted temperatures, humidity, solar radiation levels, and time-of-use electricity tariffs. Server converts external timestamps to internal time zones and normalizes units to internal standards. Server interpolates or resamples external data to match internal time granularity (for example, hourly). Server outputs external-information tables keyed by time and region, which can be joined with environment and emotion data.

### Step 10:

Server constructs feature vectors for emotion estimation.

Server receives, as input, environment state data, apparatus state data, subjective input data, vital-feature data, and external information, for a given user and a target time window. Server joins tables by user identifier and timestamp, using nearest-time or window-based matching, to create combined records containing environmental, apparatus, subjective, biological, and external attributes. Server encodes categorical values into numeric form using techniques such as one-hot encoding and normalizes continuous values using stored mean and variance parameters. Server concatenates these values into feature vectors, each vector representing the user's state at a given time or within a given interval. Server outputs feature tensors suitable for input to a machine-learning model.

### Step 11:

Server estimates emotion states using a trained machine-learning model.

Server receives, as input, the feature tensors from Step 10. Server loads a trained model, such as a neural network with multiple layers (for example, input layer, hidden layers with nonlinear activations, and output layer for comfort index, stress index, and emotion category scores).

Server performs forward propagation by multiplying feature vectors with weight matrices, adding biases, applying activation functions (for example, rectified linear units or sigmoids), and computing final outputs. Server converts raw outputs to normalized indices and selects the most likely emotion category using functions such as softmax and argmax. Server outputs emotion-state data records, each record including at least a timestamp, user identifier, comfort index, stress index, and emotion category.

### Step 12:

Server summarizes historical behavior and constructs planning inputs.

Server receives, as input, historical energy usage, environment conditions, emotion-state data, and external information for a predetermined planning horizon (for example, the past twenty-four hours and the next twenty-four hours). Server aggregates data by fixed time slots (for example, hourly) and computes derived metrics, such as average and peak power consumption per apparatus, average indoor temperature and humidity, average comfort and stress indices, and predicted electricity price per slot. Server also derives user-specific patterns, such as hours with persistently low comfort or high costs. Server outputs numerical summaries and text fragments that describe these metrics in a human-readable but structured way.

### Step 13:

Server generates a prompt sentence for the generative AI model.

Server receives, as input, the numerical summaries, text fragments, optimization objectives (for example, cost minimization and comfort maintenance), and user-preference pattern information extracted from feedback history. Server composes a prompt sentence by embedding the summaries and objectives into a multi-section text, including a role description for the generative AI model, a list of input data items, explicit optimization goals, and instructions for output format. Server arranges information in numbered lists or bullet points to make the structure explicit. Server outputs a prompt sentence that captures the state of the system and the desired optimization criteria in a form interpretable by the generative AI model.

### Step 14:

Server invokes the generative AI model with the prompt sentence.

Server receives, as input, the prompt sentence generated in Step 13. Server sends the prompt to a generative AI model implemented, for example, as a transformer-based large language model that processes token sequences. Server configures inference parameters, such as maximum response length and sampling temperature, and issues a generation request. Server obtains, as output, a natural-language response describing, for each time slot in the planning horizon, recommended values for air-conditioning setpoint temperatures, lighting brightness levels, operation timing of household apparatuses, and charge-and-discharge decisions for storage apparatuses. Server logs the raw response for auditing and downstream parsing.

### Step 15:

Server parses the generative AI model output into structured control parameters.

Server receives, as input, the natural-language response from the generative AI model. Server applies a parsing routine that locates time-slot identifiers and associated parameter values by scanning for patterns such as “Hour X: Temperature= . . . , Lighting= . . . ” Server extracts numeric values using regular expressions or a rule-based parser and converts them into internal numeric types. Server checks for missing or malformed entries and, if necessary, applies default values or requests regeneration in limited cases. Server outputs a structured list or table, where each row corresponds to a time slot and each column to a specific control parameter for a given apparatus or apparatus type.

### Step 16:

Server validates and adjusts control parameters under system constraints.

Server receives, as input, the structured control parameters from Step 15 and constraint information describing device limits and policy rules. Server checks each parameter against its allowed range, such as minimum and maximum acceptable air-conditioning temperatures, lighting brightness between zero and one hundred percent, and permissible operation windows for high-power household apparatuses. Server adjusts out-of-range values by clamping or rescheduling according to predefined algorithms, and ensures that aggregate power demand does not exceed contractual or hardware limits during any time slot. Server yields a final control plan that satisfies all constraint conditions. Server outputs the final control plan as records specifying, for each time slot and each apparatus, the corrected target parameters.

### Step 17:

Server transmits the final control plan to the terminal.

Server receives, as input, the final control plan and identifies the corresponding terminal and building. Server encapsulates the plan in a structured message specifying plan identifiers, validity periods, and per-device schedules. Server sends the message over a secure communication channel to the terminal. Server may store a copy of the transmitted plan and its metadata for later verification and debugging. Server outputs a delivered control plan that is ready to be executed by the terminal.

### Step 18:

Terminal schedules and executes apparatus control commands.

Terminal receives, as input, the final control plan from the server. Terminal parses the plan, maps logical apparatus identifiers to physical communication endpoints, and stores the schedule in a local data structure. Terminal configures a scheduler that triggers control actions at prescribed times, such as setting air-conditioning setpoints before a planned time slot begins. Terminal sends control messages over appropriate interfaces (for example, HTTP requests to smart devices, MQTT messages to subscribed topics, or vendor-specific commands over local networks). Terminal monitors responses from apparatuses, logs success or failure, and may report execution results back to the server. Terminal outputs executed control actions that modify operating states of real-world apparatuses in the building.

### Step 19:

User experiences the controlled environment and provides feedback.

User receives, as input, changed environmental conditions, such as new temperatures, humidity levels, lighting brightness, and operation schedules of household apparatuses. User observes the resulting comfort level and convenience. User decides to submit feedback by using the user terminal to select an evaluation label (for example, “comfortable”, “slightly hot”, “too dark”) and, optionally, to enter free-form comments describing preferences or complaints. User submits the feedback, which becomes a structured feedback record containing evaluation labels, textual comments, timestamps, and user identifiers. User outputs feedback that encodes subjective reaction to the system's control behavior.

### Step 20:

Server analyzes user feedback and updates models and prompt-generation logic.

Server receives, as input, structured feedback records from the user terminal and corresponding environmental, control, and emotion-state data from its database. Server joins feedback records with time-aligned records of actual temperatures, lighting levels, device operating settings, and estimated emotion states. Server identifies patterns, such as conditions that are frequently evaluated as comfortable or uncomfortable, and summarizes these patterns into user-preference pattern information (for example, recommended temperature and brightness ranges). Server uses this information to adjust parameters or post-processing rules in the emotion-estimation model and to modify templates and weighting rules used by the prompt-generation logic. Server outputs updated model configurations and prompt-generation rules, which will influence subsequent feature interpretation, prompt sentences, and generative AI model outputs.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional energy management systems for buildings and facilities primarily optimize energy usage based on physical parameters such as power consumption, temperature, and external factors such as electricity prices and weather conditions. These systems typically employ rule-based controls or conventional optimization algorithms that treat an operator as an external, static factor. As a result, they do not adapt their control behavior, explanation style, or automation level to the cognitive load, stress level, or emotional state of the human operator who supervises and approves energy optimization plans.

In practice, modern energy optimization increasingly relies on automated or semi-automated control generated by complex machine learning models, including generative AI models. As the underlying models and optimization logic become more opaque and sophisticated, operators often struggle to understand the rationale behind recommendations and control actions. This lack of transparency and adaptivity can lead to mistrust of automatic control, increased operator anxiety or stress, and conservative usage patterns in which potentially valuable optimization plans are not applied or are applied only partially. Furthermore, when extensive automatic control is enabled without regard to the operator's emotional condition, there is an increased risk of human error, delayed responses, or inappropriate overrides, which can degrade safety and reliability of the facility.

Existing systems also fail to leverage rich multimodal data that is already available at operator terminals, such as video from cameras, audio from microphones, detailed UI interaction logs, and free-text input in chat or comment interfaces. These data streams can reveal important information about the operator's cognitive state and emotional state, but conventional systems do not perform integrated emotion estimation or use such estimation to adjust the behavior of a generative AI model or the associated user interface.

Additionally, current generative AI-based optimization modules, when used, typically rely on static prompt sentences and fixed output formats. They do not adapt their prompt content or structure according to the operator's emotional state or the risk sensitivity required at a given time, and thus cannot dynamically balance between aggressive optimization and conservative, explanation-rich suggestions. There is no unified mechanism that tightly couples (i) integrated multimodal emotion estimation, (ii) prompt sentence generation for a generative AI model, (iii) generation of energy optimization plans, and (iv) adaptive control-level decisions and user interface configurations.

Accordingly, there is a need for an improved computer-implemented energy management system that: (1) acquires and integrates multimodal operator-related data together with operational and external environment data; (2) computes an emotion state of the operator and represents it as machine-readable metadata; (3) uses that emotion state metadata to dynamically generate and adapt prompt sentences for a generative AI model that outputs energy optimization plans and explanations; and (4) adjusts both the automatic control level and the user interface presented to the operator based on the emotion state. Such a system should improve the functioning of the computer system itself by providing a more context-aware orchestration of generative AI inference, control scheduling, and human-machine interaction, thereby reducing operator cognitive burden, increasing trust and safety, and enabling more effective and acceptable energy optimization in buildings.

The specific processing by the specific processing unit 290 of the data processing device 12 in Application Example 2 is realized by the following means.

The present invention provides a server comprising at least one processor and at least one memory storing instructions, wherein the processor is configured to execute the instructions to acquire operation information and environment information from information processing equipment and environment detection equipment disposed in a building, to store the acquired information as time-series information, to acquire external information including price information and weather information from an external information provision apparatus via a communication network and to generate integrated state information by aligning the external information with the operation information and the environment information on a time axis, to acquire at least one among image information, audio information, operation history information, and character string information from a terminal apparatus operated by a user, to execute image analysis processing, audio analysis processing, character string analysis processing, and operation history analysis processing on the acquired information and to integrate analysis results to generate and record emotion state metadata indicating an emotion state of the user, to generate a prompt sentence for a generative AI model by selecting contents or a format of the prompt sentence based on the emotion state metadata and the integrated state information and by embedding index values derived from the integrated state information into the prompt sentence, to input the prompt sentence and the integrated state information into the generative AI model including learned parameters and to generate operation plan information for optimizing energy usage in a predetermined period and explanation information of the operation plan information, to determine an automatic control level relating to operation conditions of energy supply equipment and energy consumption equipment based on the operation plan information and the emotion state metadata and to generate user interface metadata defining at least a display screen configuration, an arrangement of selection elements, and a default selection state of the terminal apparatus, and to generate and transmit control signals to management target equipment in accordance with the determined automatic control level and to transmit the operation plan information, the explanation information, and the user interface metadata to the terminal apparatus. This enables the computer-implemented energy management system to adapt generative AI prompt sentences, optimization outputs, control levels, and user interface behavior to the operator's emotion state, thereby improving system-level decision quality, reducing operator cognitive burden, increasing safety and acceptability of automated control, and enhancing the overall technical performance of energy optimization in buildings.

The term “system” refers to a combination of one or more computing devices, communication interfaces, and controlled equipment that cooperate to perform energy management processing as described herein.

The term “processor” refers to a hardware processing unit, such as a central processing unit or a graphics processing unit, or a combination thereof, capable of executing instructions stored in a memory to perform data acquisition, analysis, generation, and control operations.

The term “memory” refers to a non-transitory computer-readable storage medium, such as semiconductor memory, magnetic storage, or optical storage, that stores instructions and data for execution by the processor.

The term “building” refers to any physical structure or facility in which energy is consumed and managed, including but not limited to commercial facilities, industrial facilities, residential facilities, and data centers.

The term “information processing equipment” refers to one or more computing devices installed in the building, including, for example, server devices, storage devices, and network devices that consume electrical energy and whose operating conditions can be monitored or controlled.

The term “environment detection equipment” refers to one or more sensing devices that measure physical conditions in the building, such as temperature sensors, humidity sensors, air flow sensors, noise sensors, or other environmental sensors.

The term “operation information” refers to information indicating an operating state of information processing equipment, including, for example, power consumption, processor load, memory usage, processing throughput, and operating schedules.

The term “environment information” refers to information indicating physical environmental conditions in the building, including, for example, temperature, humidity, air flow, and similar environmental parameters.

The term “time-series information” refers to data records in which operation information and environment information are associated with corresponding time stamps and stored as sequences ordered along a time axis.

The term “external information provision apparatus” refers to a computing resource located outside the building that provides information via a communication network, such as an application programming interface service that supplies price information or weather information.

The term “price information” refers to information regarding energy pricing, including, for example, time-of-use tariffs, real-time prices, or forecasted prices for energy consumption.

The term “weather information” refers to information regarding environmental conditions external to the building, including, for example, outside temperature, humidity, wind speed, solar irradiance, and similar forecast or measurement data.

The term “integrated state information” refers to data generated by aligning external information with operation information and environment information on a common time axis and by combining the aligned information into a unified representation of a state of the building over a period.

The term “terminal apparatus” refers to an information processing device operated by a user, such as a desktop computer, notebook computer, tablet device, or similar client device, that provides a user interface and communicates with the server.

The term “user” refers to a human operator who monitors, supervises, or configures the energy management system through the terminal apparatus.

The term “image information” refers to data representing visual content acquired from an image capture device associated with the terminal apparatus, such as still images or video frames including a face of the user.

The term “audio information” refers to data representing sound acquired from an audio capture device associated with the terminal apparatus, such as a microphone, and including spoken utterances by the user.

The term “operation history information” refers to data representing interaction events performed by the user on the terminal apparatus, including, for example, button clicks, menu selections, page transitions, and error acknowledgements, each associated with a time stamp.

The term “character string information” refers to textual data input by the user through the terminal apparatus, including, for example, chat messages, comments, queries, and instructions.

The term “image analysis processing” refers to computer-implemented processing that analyzes image information to extract features such as facial regions and facial expressions relevant to estimation of an emotion state of the user.

The term “audio analysis processing” refers to computer-implemented processing that analyzes audio information to extract acoustic features and classify or estimate an emotion state of the user based on voice characteristics.

The term “character string analysis processing” refers to computer-implemented natural language processing that analyzes character string information to determine sentiment, emotional categories, or other affective indicators expressed in text.

The term “operation history analysis processing” refers to computer-implemented processing that analyzes operation history information to compute metrics such as frequency of certain operations, error-related behavior, or navigation patterns indicative of stress or confusion.

The term “emotion state metadata” refers to machine-readable data indicating an estimated emotion state of the user, including, for example, an emotion label such as stress level or anxiety level, associated scores, and a time stamp.

The term “generative AI model” refers to a machine learning model with learned parameters that, in response to input data and a prompt sentence, generates output information such as natural language text or structured data representing operation plan information and explanation information.

The term “prompt sentence” refers to a natural language or structured instruction sequence input to the generative AI model, specifying requested output content, conditions, or formatting for generation of operation plan information and explanation information.

The term “index values” refers to numerical or categorical values derived from the integrated state information, including, for example, predicted load levels, price levels, or environmental conditions, which are embedded into the prompt sentence.

The term “operation plan information” refers to information defining an energy optimization plan for a predetermined period, including, for example, schedules, setpoints, and control parameters for energy supply equipment and energy consumption equipment.

The term “explanation information” refers to natural language descriptions or structured explanatory data relating to the operation plan information, including, for example, rationales, expected effects, and risk descriptions.

The term “energy supply equipment” refers to equipment that provides energy within the building, such as power distribution units, energy storage units, or heating, ventilation, and air conditioning units operating as energy sources.

The term “energy consumption equipment” refers to equipment that consumes energy within the building, such as information processing equipment, lighting devices, or other electrical loads.

The term “automatic control level” refers to a degree or mode of automation with which the system applies operation plan information to energy supply equipment and energy consumption equipment, including, for example, full automatic application, simulation-only mode, or no application.

The term “user interface metadata” refers to data that defines configuration of a user interface on the terminal apparatus, including, for example, layout of display elements, arrangement of selection elements such as buttons, and default selection states.

The term “display screen configuration” refers to a logical specification of arrangement and types of visual components displayed on a screen of the terminal apparatus, including charts, text regions, and interactive controls.

The term “selection elements” refers to user interface components that allow the user to choose options, including, for example, buttons, check boxes, or selection lists corresponding to control modes for elements of the operation plan information.

The term “default selection state” refers to an initially selected option among the selection elements when the user interface is first displayed, before explicit user interaction.

The term “management target equipment” refers to any equipment whose operation can be influenced by control signals generated by the system, including energy supply equipment and energy consumption equipment.

The term “control signals” refers to data transmitted from the server to management target equipment to change or set operating parameters, such as setpoint values, on/off states, or operating modes.

The term “selection operation units” refers to concrete instances of selection elements on the user interface associated with particular operation plan elements and particular control options, such as “automatic application,” “trial evaluation only,” and “no application.” The term “highlight display” refers to a visual emphasis applied to a selection operation unit, such as color, size, or decoration, to draw attention or indicate a recommended or default choice.

The term “trial evaluation process” refers to a computer-implemented process that virtually applies operation plan information to predictive models using past measurement information and model information in order to estimate energy consumption and environment indexes without performing actual control.

The term “past measurement information” refers to historical time-series data of operation information and environment information collected from the building and used for prediction and evaluation.

The term “model information” refers to parameters and structures of predictive models or simulation models that relate control actions to resulting energy consumption and environment indexes.

The term “environment indexes” refers to quantitative indicators of environmental conditions relevant for evaluation, including, for example, temperature metrics, humidity metrics, or efficiency indicators such as power usage effectiveness.

The term “control contents” refers to details of control actions actually performed on management target equipment, including target devices, timing, and parameter changes.

The term “improvement data” refers to recorded information, including control contents and subsequent measurement information, used to adjust or improve operation plan information generation, prompt sentence generation, or other system components.

In one embodiment, a server, a terminal, and a user cooperate to implement an energy management system that optimizes energy usage in a building while adapting control behavior and user interaction to an emotion state of the user. The system is realized on conventional computer hardware and communication networks but employs specific data structures, algorithms, and a generative AI model controlled by prompt sentences to improve technical performance of energy optimization and human-machine interaction.

The server is implemented as a general-purpose computing apparatus equipped with a multi-core central processing unit (CPU), at least one graphics processing unit (GPU) used for neural network inference, a main memory, and one or more non-transitory storage devices. The server executes a server-grade operating system such as a UNIX-like operating system, and runs an application layer implemented, for example, in a general-purpose programming language together with a web application framework. The server further executes a database management system to store time-series measurement data, emotion state metadata, operation plans, and logs.

The terminal is implemented as a client computing apparatus such as a desktop computer, notebook computer, or tablet. The terminal includes a CPU, a memory, a display, an input device such as a keyboard or a pointing device, an image capture device such as a camera, and an audio capture device such as a microphone. The terminal executes a client operating system and a web browser or a dedicated client application. The terminal renders a user interface by using a client-side script language and a front-end framework and communicates with the server over an encrypted network connection.

The user operates the terminal to access a management interface provided by the server. The user authenticates to the system, monitors energy-related information, reviews operation plans suggested by the server, and selects modes of application such as automatic application or trial evaluation only.

The server acquires operation information and environment information from information processing equipment and environment detection equipment installed in the building. The server uses communication protocols such as a management protocol or an industrial bus protocol to periodically poll devices for measurements. The server stores the acquired numerical measurements in time-series tables within the database. Each table entry includes a time stamp, a device identifier, a measurement type, and a measurement value. The server processes the time-series information by using a data analysis library, for example, an in-memory data frame representation, to compute derived features such as moving averages, peak values, daily profiles, and predicted load curves. The server uses these features as part of the integrated state information that summarizes a predicted state of the building over a planning horizon.

The server acquires external information by sending HTTP or HTTPS requests to external information provision apparatuses. The server parses response messages encoded in a structured data format such as JSON. The server extracts price information such as time-of-use electricity tariffs and weather information such as predicted outside temperature, humidity, and wind speed.

The server converts all external values into normalized units, aligns them on the same time grid as the internal time-series information, and stores them in a separate external information table.

The server then generates integrated state information by joining the internal and external tables by time stamp, resulting in a data structure that, for each time point in the planning horizon, contains a vector of features including internal load metrics, device states, and external price and weather variables.

The terminal acquires user-related information by controlling the camera, the microphone, and the user interface. The terminal obtains permission from the user to access the camera and microphone through standard operating system dialogs. When permitted, the terminal captures video frames at a fixed sampling rate. The terminal resizes and compresses frames by using a graphics drawing interface such as a canvas interface, thereby reducing resolution and file size before transmission. The terminal captures audio from the microphone and segments it into fixed-length buffers. The terminal may analyze the amplitude envelope to remove periods of silence, thereby lowering network and processing load.

The terminal records operation history information by attaching event listeners to user interface components. Each time the user presses a button, selects a menu item, or triggers a navigation, the terminal records an event log entry containing at least a time stamp, a control identifier, and an event type. The terminal records error dialogs and confirmation dialogs as separate events.

The terminal records character string information by intercepting submission of text typed by the user in input fields or message boxes.

The terminal packages image information, audio information, operation history information, and character string information into a structured payload and transmits it to the server at fixed intervals or when a threshold number of events is reached. The terminal can perform simple compression and aggregation on the client side to reduce network use and to offload some preprocessing from the server. This architecture reduces the volume and frequency of data transferred, which contributes to lower communication load and improved responsiveness.

The server performs image analysis processing by using a computer vision library to decode compressed image data into arrays of pixel values. The server detects face regions by applying a face detector such as a cascade classifier or a convolutional network-based detector. The server crops and resizes the face regions to a fixed size and normalizes pixel intensities. The server feeds the normalized face images into a neural network for facial expression classification. In one embodiment, the neural network is a convolutional neural network including multiple convolution layers, pooling layers, and fully connected layers, trained to output probabilities for emotion classes such as neutral, stress, anxiety, and satisfaction. The server computes emotion scores from the output probabilities and stores them as part of the image-based emotion features.

The server performs audio analysis processing by decoding audio buffers into waveforms and resampling them to a fixed sampling frequency. The server extracts acoustic features such as mel-frequency cepstral coefficients, chroma features, and spectral features by using an audio signal processing library. The server feeds these feature vectors into a neural network for voice emotion recognition. In one embodiment, the network includes one or more recurrent layers such as long short-term memory layers or transformer-based self-attention layers on top of convolutional feature extractors. The network outputs emotion scores, for example, stress level, arousal level, or calmness level, which the server stores as audio-based emotion features.

The server performs character string analysis processing by applying a tokenizer to the character string information and converting text into token indices. The server inputs the token sequences into a pre-trained language representation model, such as a transformer-based encoder, that has been fine-tuned on emotion and sentiment classification tasks. The model produces an embedding vector for each text input and classification logits. The server converts the logits to probabilities, identifies categories such as negative sentiment, anxiety, or confusion, and stores these as text-based emotion features along with the embedding vectors if needed for further fusion.

The server performs operation history analysis processing by aggregating event logs over sliding time windows. The server computes metrics such as the number of repeated clicks on the same control, the number of navigation reversals between the same two screens, and the frequency of actions performed immediately after an error dialog. The server applies a rule set or a statistical classifier to the computed metrics to derive a stress index and a confusion index. For example, the server can apply threshold rules or a logistic regression model trained to output a probability that the user is under high cognitive load based on these metrics.

The server integrates the image-based, audio-based, text-based, and operation-based emotion features through an emotion integration module. The server may use a weighted linear combination of modality-specific scores, where the weights are calibrated in advance or adapted online. Alternatively, the server may use a shallow neural network that takes as input a concatenation of modality-specific feature vectors and outputs a final emotion state vector. The server converts the emotion state vector into discrete labels such as “high-stress/high-anxiety,” “medium stress,” or “normal” by applying boundaries in the emotion space. The server constructs emotion state metadata that includes at least the emotion label, a set of numeric scores, and a time stamp, and stores it in a database table keyed by user or session. The server also caches the latest emotion state metadata in memory for fast access by other modules.

The server generates a prompt sentence for a generative AI model based on the integrated state information and the emotion state metadata. The server manages multiple prompt templates stored in configuration data structures. Each template corresponds to a different emotion state class or risk level. The server selects a template by matching the current emotion label. The server populates placeholders in the selected template with values derived from the integrated state information such as predicted peak load, time-of-use price peaks, and weather extremes.

The server obtains these values by querying the integrated state data structure over the planning horizon.

For example, when the user is in a normal state, the server can generate a prompt sentence such as:

“Based on the forecasted server load for the next 24 hours (peak 800 kW at 15:00), the time-of-use electricity prices (maximum 32 JPY/kWh at 19:00), the predicted outside temperature and wind speed, and the forecast of renewable energy supply, propose an operating schedule for the data center's cooling systems and a maintenance schedule for the servers that minimizes the total energy consumption. Include for each hour the expected energy consumption (kWh), cost (JPY), and estimated PUE, and quantify the expected energy savings compared to the current baseline. Also list the main data items used as the basis for each proposal and briefly explain their contributions in a bullet-point sensitivity summary.”

When the user is in a high-stress or high-anxiety state, the server can generate a different prompt sentence such as:

“Based on the forecasted server load for the next 24 hours, the time-of-use electricity prices, the predicted outside temperature and wind speed, and the forecast of renewable energy supply, propose an operating schedule for the data center's cooling systems and a maintenance schedule for the servers that will reduce total energy consumption. The current operator is estimated to be in a high-anxiety state. Therefore, you must: (1) list the main risks associated with each proposal and their likelihoods, (2) describe the impact range if a problem occurs, and (3) provide a safer alternative plan that reduces those risks. Avoid technical jargon and explain everything in simple language. For each proposal, also create explanation text that will be used to present three options to the operator: ‘apply automatically,’ ‘run simulation only,’ and ‘do not apply.’”

The server thus changes not only the wording but also the required structure and content of the generative AI model's output by modifying the prompt sentence. This prompt generation mechanism leads to a technical effect: the generative AI model's output becomes more structured and more directly usable by downstream modules that extract control parameters and user interface metadata. By embedding index values and explicit instructions in the prompt sentence, the server reduces the need for complex post-processing heuristics and improves overall processing speed and robustness.

The server implements the generative AI model as a trained neural sequence model. In one embodiment, the model is a transformer-based language model with multiple self-attention layers and feedforward sublayers. The model parameters are learned in advance by minimizing a loss function such as a cross-entropy loss over a large corpus of training sequences, using an optimization algorithm such as stochastic gradient descent with adaptive learning rate adjustment. During training, the server or an external training environment applies techniques such as mini-batch training, gradient clipping, and regularization. Data augmentation may be applied in the form of paraphrasing or random masking to improve robustness. After training, the server deploys the model weights to a model inference engine that runs on the GPU.

The server performs inference by tokenizing the prompt sentence into token identifiers and feeding them to the generative AI model. The model computes hidden representations and generates output tokens sequentially or in parallel, according to the architecture. The server uses decoding strategies such as beam search or top-k sampling to generate diverse yet controlled responses. The server constrains the maximum output length and may enforce structural tokens corresponding to sections like “PLAN,” “RISKS,” and “ALTERNATIVES.” By doing so, the server shapes the generative process so that the output can be systematically parsed.

The server parses the generated text by scanning for known section markers or formatting patterns requested in the prompt sentence. The server extracts operation plan information such as time-indexed setpoints for cooling devices, scheduled maintenance windows for information processing equipment, and limits on power consumption. The server maps these parameters into internal data structures representing device-specific schedules, where each entry contains a device identifier, a time interval, and a target value. The server additionally parses explanation information such as predicted energy savings, qualitative risk descriptions, and suggested operator choices.

The server then determines an automatic control level for each part of the operation plan information based on the emotion state metadata and possibly the risk classification present in the explanation information. For plan elements classified as low-risk when the user is in a normal state, the server can allow automatic application as a default control mode. For plan elements in a high-stress or high-anxiety state, the server can set trial evaluation only as the default. The server generates user interface metadata that associates each plan element with selectable options such as automatic application, trial evaluation only, and no application, and specifies default selection states and emphasis attributes.

The terminal receives the operation plan information, explanation information, and user interface metadata and renders a user interface screen that visualizes predicted energy consumption, costs, and efficiency indices using charts and tables. The terminal displays the text explanations and risk assessments and presents selection operation units for each plan element. The terminal highlights default or recommended options as specified in the user interface metadata. The user reviews the displayed information and interacts with the selection operation units to choose how each plan element should be applied.

The server receives the user's selections and executes either a trial evaluation process or an actual control process. In the trial evaluation process, the server loads past measurement information and model information and simulates the effect of the operation plan information. The server may implement a simplified thermal model and power model, for example, computing temperature responses and energy consumption using difference equations parameterized by device capacities and environmental variables. The server produces predicted time-series of energy consumption and environment indices and returns them to the terminal for visualization. This enables the user to verify the impact of the plan before actual application.

In the actual control process, the server translates operation plan elements into control signals for management target equipment. For a cooling device, the control signal may include a new temperature setpoint and fan speed level. For an information processing device, the control signal may include a power cap or a schedule for workload migration. The server transmits these control signals via control protocols to the target devices. The devices then adjust their operation accordingly, changing the real physical conditions such as temperature and power draw in the building. This coupling of the generative AI-based planning with actual device control ensures that the claimed system is not limited to abstract data processing but directly affects the physical environment.

The server records all control contents and subsequent measurement information. The server computes deviations between predicted and actual results, logs them into evaluation tables, and optionally adjusts model parameters or prompt generation strategies over time. For example, if a specific template consistently leads to overestimation of energy savings under certain load patterns, the server can adjust the index values or modify the prompt sentences to request more conservative plans. By closing this loop, the server improves the accuracy and reliability of the energy optimization process.

The use of multimodal emotion estimation and prompt-controlled generative AI provides technical improvements beyond mere automation of human decision-making. The emotion estimation module reduces unnecessary automatic execution when the user is under stress, decreasing the likelihood of critical human errors and thereby enhancing safety. The prompt generation module encodes state-dependent requirements into prompt sentences, which enables the generative AI model to produce structured, machine-parseable outputs more efficiently and with fewer post-processing errors. The system's architecture, in which emotion state metadata feeds into both prompt sentence generation and control policy selection, leads to reduced computation overhead in downstream modules because the model is guided to generate only relevant sections and data types.

In alternative embodiments, the server can employ different neural network architectures for emotion detection or generative modeling, such as convolutional-recurrent hybrids, variational transformers, or mixture-of-experts models. The server can modify the set of modalities, for example, relying only on image information and operation history information if audio capture is unavailable. The server can change the planning horizon and the granularity of time steps while maintaining the same integration and prompt generation logic. In all such variations, the core concept remains that the server computes emotion state metadata from multimodal user-related data, uses that metadata to control prompt sentences provided to a generative AI model, and then uses the output to generate operation plans and adaptive user interfaces that govern real-world equipment control.

Thus, the described embodiments provide concrete, technical mechanisms for improving computer-based energy management in buildings by integrating emotion-aware control of generative AI models, structured prompt sentence generation, efficient data fusion, and closed-loop control of physical devices.

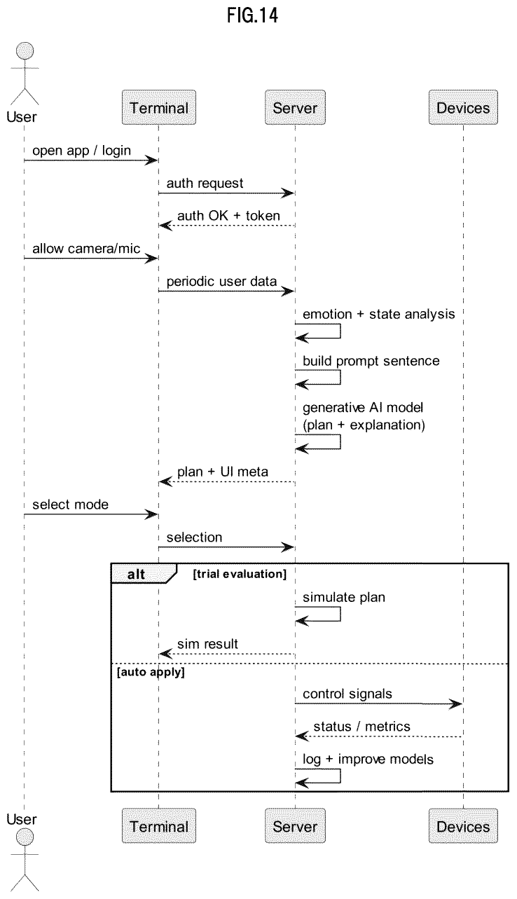

The following describes the processing flow using FIG. 14.

### Step 1:

User starts the client application or browser on terminal and accesses a management URL of server.

Terminal sends an HTTPS request to server and receives an authentication page.

User inputs authentication information such as a user identifier and a password into the login form.

Terminal uses the user identifier and the password as input, constructs an HTTPS POST request containing these values in a structured body, and transmits the request to server.

Server receives the authentication request as input, queries a database table storing account records, and compares a hash value of the received password with a stored hash value.

Server outputs either an authentication success response containing a session token and initial dashboard data, or an authentication failure response containing error information.

### Step 2:

Terminal receives, as input, the authentication response including the session token and the initial dashboard data.

Terminal stores the session token in a secure storage area such as a session storage of the browser, and uses the initial dashboard data to render charts and summary panels on the display.

Terminal outputs a rendered dashboard screen and a client-side state that includes the session token and current view information.

Terminal additionally displays a permission dialog asking user to allow access to a camera and a microphone.

User reads the permission dialog and either grants or denies permission.

Terminal uses the permission decision as input, calls a media access interface to start or skip acquisition of camera video streams and microphone audio streams, and outputs either active media streams or a disabled media acquisition state.

### Step 3:

Terminal, when media acquisition is enabled, receives a continuous video stream and audio stream as input from the camera and the microphone.

Terminal sets a timer and, at fixed intervals, captures a video frame into an off-screen drawing surface.

Terminal applies a resizing operation and compression encoding to the captured frame, thereby performing data reduction and generating a compressed image object.

Terminal outputs, for each interval, a compressed image object containing pixel data of the user's face region and a time stamp.

Terminal segments the audio stream into short-duration buffers, optionally applies silence trimming or down-sampling as data preprocessing, and outputs short audio buffers with corresponding time stamps.

### Step 4:

Terminal monitors user interaction events such as button clicks, menu selections, and page transitions as input from the user interface.

Terminal records each event as an operation history record including at least a time stamp, a control identifier, an event type, and a current screen identifier.

Terminal also monitors text input fields; when user submits text such as a comment or query, terminal captures the submitted string together with a time stamp as character string information.

Terminal periodically aggregates compressed image objects, audio buffers, operation history records, and character string information into a batch structure.

Terminal outputs, at each aggregation interval, a batched payload that combines all collected multimodal data, and transmits this payload to server as an HTTPS request including the session token.

### Step 5:

Server receives, as input, the batched payload containing image information, audio information, operation history information, and character string information.

Server decodes each compressed image into a pixel matrix and applies a face detection algorithm to locate face regions.

Server crops and resizes each detected face to a fixed resolution and normalizes pixel values, thereby performing image preprocessing.

Server inputs the preprocessed face images into a facial expression classification network and performs a forward pass to compute emotion probabilities for each image.

Server outputs image-based emotion features including probabilities for classes such as neutral, stress, anxiety, and satisfaction.

### Step 6:

Server receives audio buffers from the batch as input and converts each buffer into a waveform representation.

Server applies signal processing to extract acoustic features such as mel-frequency cepstral coefficients and spectral statistics.

Server feeds the acoustic feature vectors into a voice emotion recognition network and performs neural inference to estimate voice-based emotion scores.

Server outputs audio-based emotion features including numeric values such as stress level or calmness level.

### Step 7:

Server takes character string information as input and tokenizes each text string using a text tokenizer.

Server feeds the token sequences into a language representation model, computes embedding vectors and classification scores, and determines emotion-related categories such as anxiety or negative sentiment.

Server outputs text-based emotion features including category labels and associated probabilities.

### Step 8:

Server receives, as input, operation history information records within a recent time window.

Server computes interaction metrics such as counts of rapid repeated clicks, back-and-forth navigation motions, and actions immediately following error dialogs by aggregating over time stamps and event types.

Server applies a rule set or a statistical classifier to these metrics to derive numeric indicators such as a stress index and a confusion index.

Server outputs operation-based emotion features including the stress index and the confusion index.

### Step 9:

Server integrates the image-based emotion features, audio-based emotion features, text-based emotion features, and operation-based emotion features as input to an emotion integration module.

Server either concatenates feature vectors or combines scalar scores and applies a fusion algorithm such as weighted summation or a shallow neural network to produce a unified emotion state vector.

Server compares components of the unified emotion state vector with predefined thresholds to assign an emotion label such as “high-stress/high-anxiety,” “medium stress,” or “normal.” Server outputs emotion state metadata including the assigned label, component scores, and a time stamp, and stores this metadata in a database and a memory cache.

### Step 10:

Server acquires, as input, operation information and environment information from information processing equipment and environment detection equipment, and acquires external information including price information and weather information from an external information provision apparatus.

Server aligns time stamps across these different sources, interpolates missing entries, and generates integrated state information represented as a time-indexed data structure where each index corresponds to a feature vector including load metrics, device states, prices, and weather parameters.

Server outputs the integrated state information and retains it for subsequent planning and prompt sentence generation.

### Step 11:

Server takes as input the emotion state metadata and the integrated state information and accesses a set of prompt templates for a generative AI model.

Server selects one prompt template according to the emotion label in the emotion state metadata, for example a detailed optimization template for a normal state or a risk-focused template for a high-stress state.

Server queries the integrated state information to obtain index values such as predicted peak load, maximum price, and significant weather conditions, and replaces placeholders in the selected template with these numeric or categorical values.

Server outputs a completed prompt sentence that encodes both the current integrated state and behavior instructions for the generative AI model.

### Step 12:

Server uses the prompt sentence and the integrated state information as input to a generative AI model.

Server tokenizes the prompt sentence into token identifiers, feeds the tokens (and optionally additional numeric features) into a neural sequence model, and performs inference on a GPU to generate output tokens until a termination condition is met.

Server decodes the output tokens into text and separates the text into logical sections based on markers requested in the prompt sentence, such as plan descriptions, risk descriptions, and alternative plans.

Server outputs operation plan information, comprising structured parameters such as device schedules and setpoints, and explanation information, comprising natural language explanations and risk assessments.

### Step 13:

Server takes, as input, the operation plan information and the emotion state metadata and evaluates risk and criticality for each plan element.

Server determines an automatic control level for each element, setting modes such as automatic application, trial evaluation only, or no application based on the emotion label and any risk tags present in the explanation information.

Server generates user interface metadata that associates each plan element with selection options, default options, and emphasis styles for display on terminal.

Server outputs the operation plan information, the explanation information, and the user interface metadata, and transmits them to terminal as a response message.

### Step 14:

Terminal receives the operation plan information, the explanation information, and the user interface metadata as input from server.

Terminal renders visual components such as charts and tables that display predicted energy consumption, costs, and efficiency indexes corresponding to the operation plan information.

Terminal displays text explanations and risk summaries and instantiates user interface controls according to the user interface metadata, including selection operation units for automatic application, trial evaluation only, and no application, with appropriate default selections and highlight styles.

Terminal outputs an interactive screen to the display and a client-side state reflecting current plan and selections.

### Step 15:

User inspects the displayed operation plan information and explanation information, evaluates the presented options, and selects a preferred mode for each plan element by operating the selection operation units.

Terminal captures the user's selections as input, combines each selection with an identifier of the corresponding plan element, and forms a control decision payload.

Terminal outputs a control decision payload and transmits it to server as an authenticated HTTPS request.

### Step 16:

Server receives, as input, the control decision payload containing user selections for plan elements.

Server parses the payload, separates plan elements into groups based on selected modes, and for each element with a trial evaluation selection, prepares simulation input data consisting of the plan parameters and relevant past measurement information and model information.

Server executes a trial evaluation algorithm that virtually applies plan parameters to predictive models and computes predicted time-series of energy consumption and environment indexes.

Server outputs simulation results for each such plan element and transmits the results back to terminal for visualization.

### Step 17:

Server, for each plan element with an automatic application selection, converts the corresponding plan parameters into device-specific control signals.

Server uses communication interfaces to send control signals to management target equipment, such as setting new temperature setpoints or power caps, and receives status responses from the devices.

Server records control contents and subsequent measurements, including energy and environmental measurements collected after control, in log tables.

Server outputs acknowledgment information indicating that control has been executed and stores recorded information as improvement data for later adjustment of operation plan generation and prompt sentence generation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

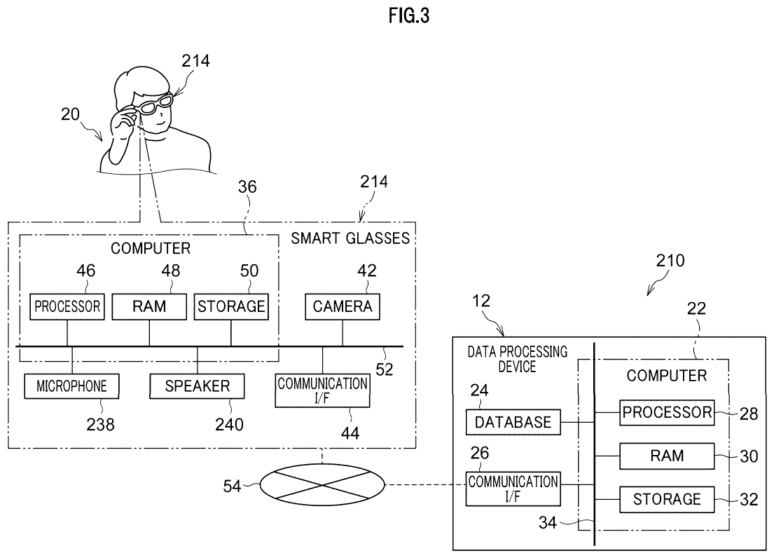

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

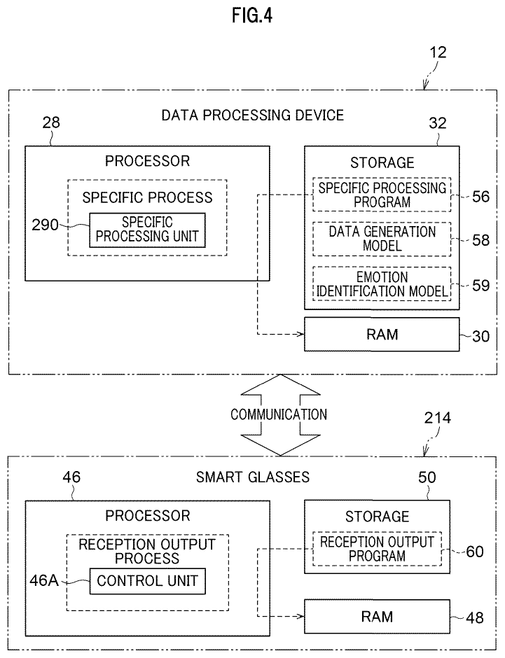

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

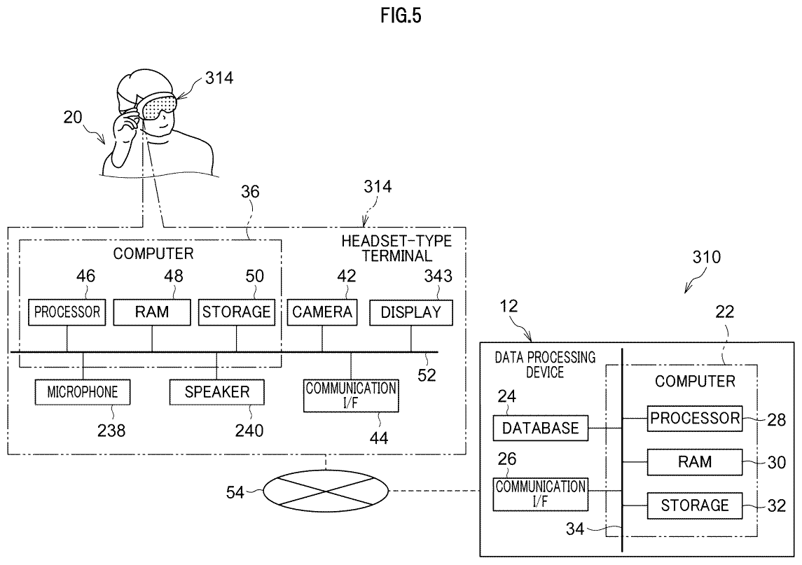

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

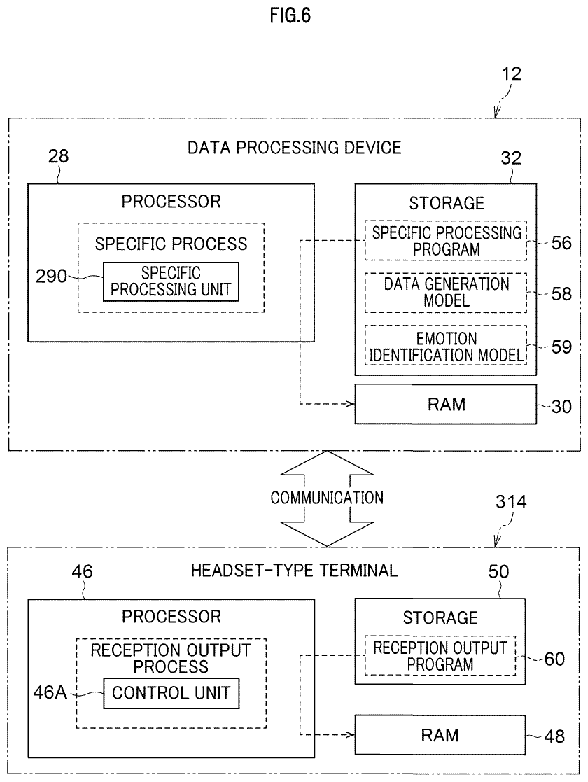

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

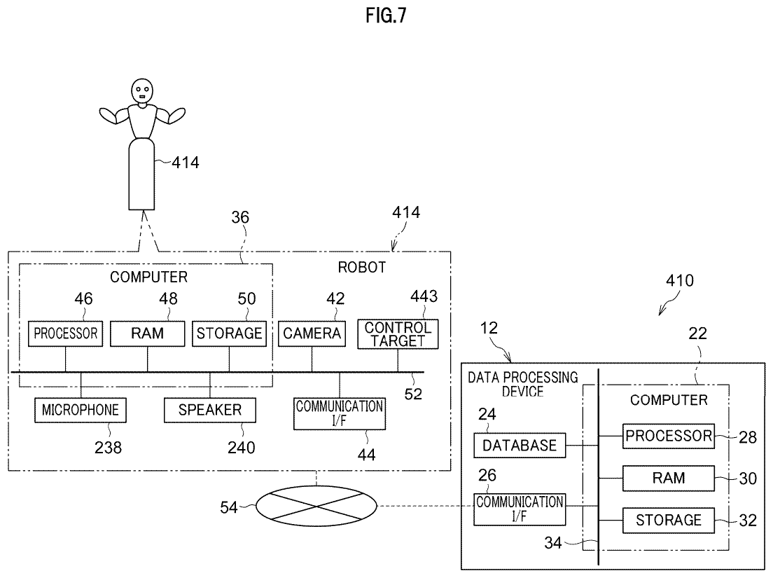

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

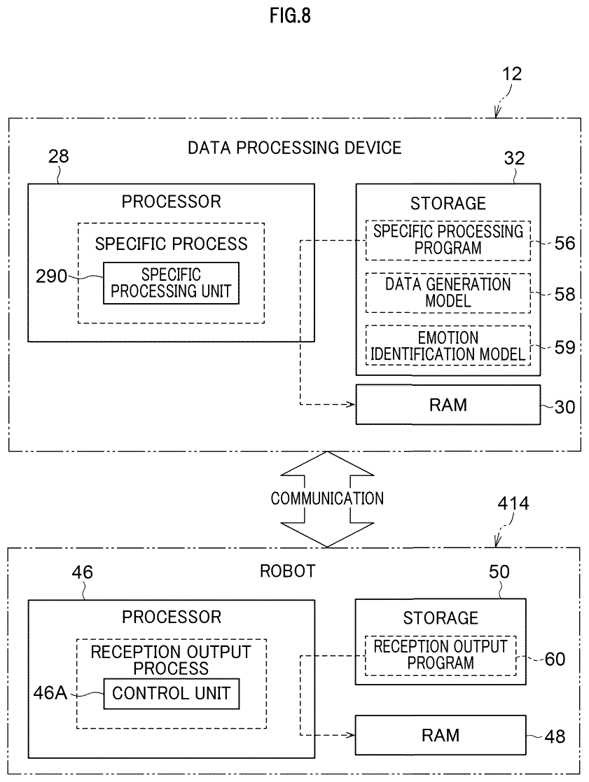

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

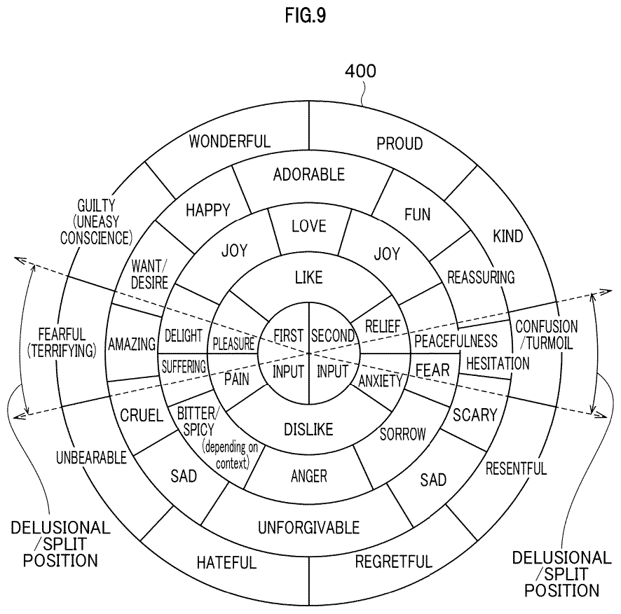

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

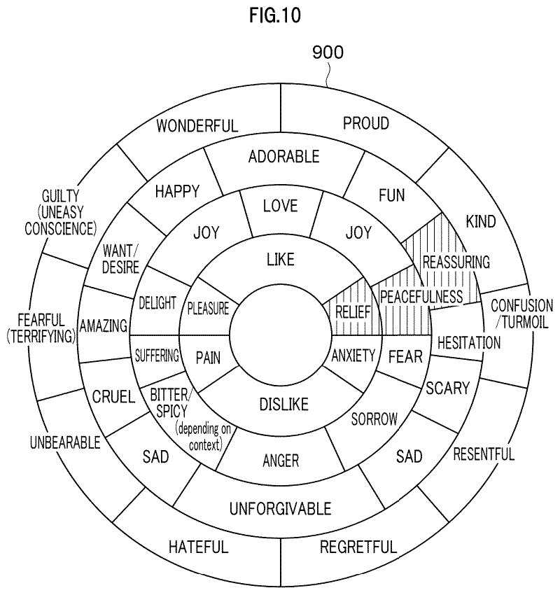

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, from a plurality of measurement apparatuses and electric apparatuses installed in a residential or building environment, time-series energy-usage information and environmental information, aggregate the acquired information by time and by spatial zone, store the aggregated information in an internal storage, and periodically transmit the aggregated information to an external processing apparatus via a communication network,
wherein the processor is configured to, in the external processing apparatus, align the energy-usage information and the environmental information with external environment information and pricing information acquired from a weather-information providing apparatus and a tariff-information providing apparatus on a common temporal and spatial basis, generate feature information including a usage-pattern indicator and a pricing indicator, and generate a prompt sentence composed of textual information including the feature information and an occupant comfort condition,
wherein the processor is configured to supply the prompt sentence as an input to a generative AI model, and to obtain, from the generative AI model, energy-usage optimization plan information including, for each interior space, an air-conditioning setting value, an operation start time and an operation end time of each electric apparatus, and a charge amount and a discharge amount of an energy-storage apparatus,
wherein the processor is configured to verify the optimization plan information, determine whether the optimization plan information satisfies a predetermined temperature range, an operation-time condition, and a pricing constraint, correct a portion that does not satisfy the conditions, and convert the optimization plan information into a concrete control schedule for each terminal apparatus,
wherein the processor is configured to, in accordance with the concrete control schedule, instruct, via the terminal apparatus, a climate-control apparatus, an illumination apparatus, a housekeeping apparatus, and the energy-storage apparatus regarding an operation mode, a setting value, and an operation time, obtain an execution result from each apparatus, and transmit feedback information including the execution result to the external processing apparatus,
wherein the processor is configured to receive, from a user operation apparatus, information including a comfort priority, an allowable temperature range, and an allowable operation time band for each apparatus, and to reflect the received information in generation of the prompt sentence and in generation of the optimization plan information,
and wherein the processor is configured to use the feedback information and evaluation information from an occupant to update contents of the prompt sentence and instruction conditions for the generative AI model, and to sequentially improve the energy-usage optimization plan information.

### (Supplementary 2)

The system according to supplementary 1,
wherein the processor is configured to construct the prompt sentence so as to include aggregated values of time-band-specific energy usage during a predetermined past period, statistical values of temperature and humidity for each interior space, time-band-specific unit-price information based on a tariff structure, an occupant comfort condition, and an operation constraint condition for each apparatus, and to specify, to the generative AI model, an output format requesting generation of structured information describing, for each time unit, a setting value and an apparatus state.

### (Supplementary 3)

The system according to supplementary 1,
wherein the processor is configured to, on the basis of the feedback information, evaluate an actual peak-power reduction amount, a cost-reduction amount, and a temperature deviation for each interior space resulting from execution of the optimization plan information, add textual information including an evaluation result to the prompt sentence, and re-input the prompt sentence to the generative AI model so that the generative AI model generates, for future operation, energy-usage optimization plan information that improves both peak-power reduction and occupant comfort.

### Application Example 1

### (Supplementary 1)

A system comprising a processor,
wherein the processor is configured to
acquire, by an internal data acquisition unit, energy-related measurement data from a plurality of measurement devices installed in a controlled facility, the energy-related measurement data including electric power values, environmental condition values, and operational state values, and to store the energy-related measurement data in a storage unit together with time information and facility-related attribute information,
acquire, by an external data acquisition unit, external environment data from an external information source via a communication network, the external environment data including price information of an energy resource, weather information, and information on availability of an energy supply source, and to store the external environment data in the storage unit together with time information,
perform, by a data processing unit, data synchronization processing to temporally align the energy-related measurement data and the external environment data, and data cleaning processing including interpolation of missing values and removal or correction of abnormal values, to generate unified time-series data,
perform, by the data processing unit, feature extraction processing on the unified time-series data to calculate aggregated indicators and derived indicators relating to energy usage and environmental conditions for each of a plurality of equipment groups and space regions in the controlled facility,
construct, by a prompt generation unit, a prompt sentence and associated structured data for a generative AI model, the prompt sentence describing at least the aggregated indicators, the derived indicators, operational constraints including allowable ranges of environmental conditions and operational availability of equipment, and an optimization objective relating to reduction of energy cost or improvement of energy efficiency, and the associated structured data including time-series records of the aggregated indicators, the derived indicators, and the external environment data,
transmit, by a model execution unit, the prompt sentence and the associated structured data to the generative AI model via an interface, and receive, from the generative AI model, an optimization plan represented in a machine-readable format, the optimization plan including time-stamped control actions for a plurality of energy-related devices and environmental control devices,
analyze, by a plan interpretation unit, the optimization plan to extract individual control actions, and verify the individual control actions against predetermined safety constraints and operational constraints, and modify or discard a control action that does not satisfy the predetermined safety constraints or the operational constraints to generate a validated control plan, and
control, by a control unit, the plurality of energy-related devices and the environmental control devices in the controlled facility in accordance with the validated control plan by outputting concrete control commands over a control interface, thereby adjusting operational states of the plurality of energy-related devices and the environmental control devices so as to optimize energy usage of the controlled facility.

### (Supplementary 2)

The system according to supplementary 1,
wherein the processor is configured to
receive, via a user terminal, user input including at least one of a modification of the operational constraints, a specification of a time period for maintenance of equipment, and a preference relating to a trade-off between energy cost reduction and service quality, update configuration information stored in the storage unit based on the user input, and reflect the updated configuration information in subsequent construction of the prompt sentence and in verification of the optimization plan generated by the generative AI model.

### (Supplementary 3)

The system according to supplementary 1,
wherein the processor is configured to
store historical records of the unified time-series data, the optimization plan generated by the generative AI model, the validated control plan, and results of execution of the validated control plan, perform analysis of the historical records to identify effectiveness of past control actions with respect to at least one of energy cost, energy efficiency, and operational stability, and update at least one of a rule set used in the verification of the optimization plan, a template of the prompt sentence for the generative AI model, and parameters of a predictive model used for forecasting energy usage, based on a result of the analysis.

### Example 2

### (Supplementary 1)

A system comprising a processor,
wherein the processor is configured to
acquire energy usage information and environmental state information from detection devices and apparatuses installed in a building, organize the energy usage information and the environmental state information as time-series data based on time information, perform preprocessing including unit conversion, missing-value completion, and smoothing, store the preprocessed data as state-information tables, and transmit the state-information tables to an external apparatus,
receive subjective input information including comfort evaluations, thermal sensations, activity states, and desired modes from a user information-processing apparatus, receive biological information including heart rate, heart rate variability, body movement, and sleep state from a wearable apparatus, calculate statistical values for the biological information for each predetermined time window to generate vital-feature data, integrate the vital-feature data and the subjective input information with the state-information tables based on a time axis, and store integrated emotion-related datasets for each user,
acquire external information including weather information and time-of-use electricity price information from an external information-providing apparatus via a communication network, and organize the external information as external-information tables based on time information and region information,
generate feature vectors representing indoor environmental states, apparatus states, subjective input states, and biological states based on the integrated emotion-related datasets and the external-information tables, input the feature vectors to a trained machine-learning model, estimate an emotion state including at least a comfort index, a stress index, and an emotion category for each user, and store emotion-state data associated with time information and user identification information,
acquire, for a predetermined period, energy usage information, environmental state information, external information, and the emotion-state data, generate numerical summary information and explanatory text including, for each time period, energy consumption, indoor environmental state, electricity price, and emotion indices, and generate a prompt sentence that describes instructions and premises to be provided to a generative AI model, the prompt sentence including optimization targets comprising at least suppression of energy cost and maintenance of a user comfort index above a predetermined threshold and including a user desired mode,
input the prompt sentence to the generative AI model to cause inference processing to be executed, obtain text data representing an energy-usage optimization plan including, for each time period in the predetermined period, an air-conditioning setting temperature, a lighting output level, an operation schedule for household apparatuses, and a charge-and-discharge plan for a storage apparatus, and parse the text data to generate, as a structured representation, a set of control parameters for each apparatus for each time period,
verify the set of control parameters against constraint conditions including at least a permissible range of the air-conditioning setting temperature, a permissible range of the lighting output level, allowable operation time bands of the household apparatuses, and input-and-output constraints of the storage apparatus, correct the set of control parameters so as to satisfy the constraint conditions to generate a final control plan, and transmit the final control plan to an apparatus that performs data collection,
generate specific control commands for air-conditioning apparatuses, lighting apparatuses, and household apparatuses corresponding to a current time based on the final control plan, transmit the specific control commands to the respective apparatuses via a predetermined communication method so as to automatically set or change operating conditions of the respective apparatuses, and acquire and record control-result information, and
receive comfort or discomfort evaluations and free-form feedback from the user, store the evaluations and the feedback in association with indoor environmental states, control conditions, and the emotion-state data at times of the evaluations, extract user-preference pattern information based on the stored data, and update at least one of parameters or correction rules of the machine-learning model and a prompt-generation logic for the prompt sentence based on the user-preference pattern information.

### (Supplementary 2)

The system according to supplementary 1,
wherein the processor is configured to group raw data acquired from the detection devices and the apparatuses in the building into units of predetermined time intervals, perform completion processing for missing times and correction processing for outliers to generate an environmental-state table and an apparatus-state table, serialize the environmental-state table and the apparatus-state table into a structured-data format on a per-transmission basis, and transmit the serialized data to an external apparatus.

### (Supplementary 3)

The system according to supplementary 1,
wherein the processor is configured to dynamically change the prompt sentence for the generative AI model based on at least (i) summarized information of energy-usage patterns, external-environment variations, and transitions of the emotion state for the predetermined period, and (ii) user-preference pattern information including comfortable conditions and uncomfortable conditions extracted for each user, and to cause the generative AI model to generate the energy-usage optimization plan such that operation of high-power-consumption apparatuses is concentrated in time periods with lower electricity prices and such that temperature ranges and illuminance ranges evaluated as comfortable by the user are preferentially reflected.

### Application Example 2

### (Supplementary 1)

A system comprising a processor,
wherein the processor is configured to
acquire operation information and environment information from information processing equipment and environment detection equipment disposed in a building, and store the acquired operation information and environment information as time-series information,
acquire external information including price information and weather information from an external information provision apparatus via a communication network, and generate integrated state information by aligning the external information with the operation information and the environment information on a time axis,
acquire at least one among image information, audio information, operation history information, and character string information from a terminal apparatus operated by a user, execute image analysis processing, audio analysis processing, character string analysis processing, and operation history analysis processing for the acquired information, integrate analysis results of the respective processing, and generate and record emotion state metadata indicating an emotion state of the user,
generate a prompt sentence for a generative AI model by selecting contents or a format of the prompt sentence based on the emotion state metadata and the integrated state information, and by embedding index values derived from the integrated state information into the prompt sentence, input the prompt sentence and the integrated state information into the generative AI model including learned parameters, and generate operation plan information for optimizing energy usage in a predetermined period and explanation information of the operation plan information, determine an automatic control level relating to operation conditions of energy supply equipment and energy consumption equipment based on the operation plan information and the emotion state metadata, and generate user interface metadata defining at least a display screen configuration, an arrangement of selection elements, and a default selection state of the terminal apparatus, and
generate and transmit control signals to management target equipment in accordance with the determined automatic control level, and transmit the operation plan information, the explanation information, and the user interface metadata to the terminal apparatus.

### (Supplementary 2)

The system according to supplementary 1,
wherein the processor is configured to
cause the terminal apparatus, based on the operation plan information and the user interface metadata, to visually display on a display screen information including predicted energy consumption, price, efficiency indexes, and risk explanation, to generate for each element of the operation plan information at least three types of selection operation units including “automatic application,” “trial evaluation only,” and “no application,” to change highlight display and an initial selection state of the selection operation units in accordance with the emotion state metadata, and to transmit a selection result from the user to the processor.

### (Supplementary 3)

The system according to supplementary 1,
wherein the processor is configured to
execute, for each element of the operation plan information, when “trial evaluation only” is selected in the selection result, a trial evaluation process of predicting energy consumption and environment indexes in a case where the operation plan information is virtually applied, by using past measurement information and model information, and transmit a result of the trial evaluation process to the terminal apparatus, and execute, when “automatic application” is selected in the selection result, actual control by transmitting the control signals to the management target equipment, record control contents and measurement information after the control, and use the recorded information as improvement data for the operation plan information generation and the prompt sentence generation.

What is claimed is:

1. A system comprising:
circuitry configured to:
receive, via a communication interface coupled to a packet-switched network, sensor data from a plurality of monitoring devices installed in a facility;
acquire external environmental data from one or more external data sources via the packet-switched network;
analyze the sensor data and the external environmental data to identify usage patterns and generate an optimization plan; and
transmit control instruction data to the plurality of monitoring devices via the communication interface based on the optimization plan.

2. The system according to claim 1, wherein the sensor data includes at least power consumption data, temperature data, and humidity data, and wherein the plurality of monitoring devices includes at least one of a power meter, a temperature sensor, a humidity sensor, an illuminance sensor, and a controllable appliance interface.

3. The system according to claim 2, wherein the circuitry stores the sensor data as time-series records in a storage device indexed by device identifier and timestamp, and trains a machine learning model on the time-series records to learn the usage patterns.

4. The system according to claim 3, wherein the external environmental data includes at least weather forecast data, electricity rate schedule data, and solar radiation data, and wherein the circuitry correlates the external environmental data with the sensor data to identify external factors influencing the usage patterns.

5. The system according to claim 4, wherein the machine learning model comprises a neural network trained on historical sensor data and corresponding external environmental data to predict future consumption patterns, and wherein the circuitry generates the optimization plan by identifying scheduling adjustments that minimize cost based on the electricity rate schedule data.

6. The system according to claim 5, wherein the circuitry constructs a prompt data structure encoding the predicted consumption patterns, the current sensor data, and optimization constraints, transmits the prompt data structure to a generative neural network model comprising a transformer-based architecture, and receives a natural language explanation of the optimization plan for display to a user via a terminal device.

7. The system according to claim 1, wherein the circuitry updates the optimization plan in real time in response to changes in the external environmental data, and transmits updated control instruction data to the plurality of monitoring devices.

8. The system according to claim 7, wherein the control instruction data includes at least one of thermostat setpoint adjustments, lighting level adjustments, and appliance scheduling commands, and wherein the circuitry verifies that each control instruction satisfies comfort constraint parameters stored in a storage device before transmission.

9. The system according to claim 8, wherein the comfort constraint parameters include temperature range bounds, minimum illuminance levels, and user-specified operational schedules, and wherein the circuitry overrides optimization recommendations that violate the comfort constraint parameters.

10. The system according to claim 1, wherein the circuitry detects anomalous consumption patterns by comparing the sensor data against predicted patterns, and generates anomaly alert data when consumption deviates from predicted values by more than a threshold.

11. The system according to claim 10, wherein the circuitry classifies detected anomalies into categories including equipment malfunction, unexpected load, and environmental deviation, and includes the classification in the anomaly alert data transmitted to a terminal device.

12. The system according to claim 11, wherein the circuitry constructs a diagnostic prompt data structure encoding the anomaly data and associated sensor readings, transmits the prompt data structure to a generative neural network model, and receives diagnostic recommendation text identifying likely causes and corrective actions.

13. The system according to claim 1, wherein the circuitry generates periodic consumption report data summarizing total consumption, cost, savings achieved relative to baseline, and environmental impact metrics, and transmits the consumption report data to a terminal device.

14. The system according to claim 13, wherein the circuitry compares the consumption report data against target reduction goals stored in the storage device, and generates progress tracking data including trend information and projected goal achievement timelines.

15. The system according to claim 1, wherein the circuitry is further configured to receive user preference data from a terminal device specifying priority between cost minimization and comfort preservation, and to adjust weighting parameters in the optimization plan based on the user preference data.

16. The system according to claim 15, wherein the circuitry learns the user preference data over time by analyzing user override patterns of the control instruction data, and automatically adjusts the weighting parameters to align with observed user behavior.

17. The system according to claim 1, wherein the circuitry integrates renewable energy generation data from monitoring devices included in the plurality of monitoring devices, predicts generation capacity based on weather forecast data, and schedules high-consumption operations during predicted peak generation periods.

18. A system comprising:
circuitry configured to:
receive, via a communication interface coupled to a packet-switched network, sensor data from a plurality of monitoring devices installed in a facility, the sensor data including power consumption data, temperature data, and humidity data;
acquire external environmental data including weather forecast data and rate schedule data from external data sources via the packet-switched network;
analyze the sensor data and the external environmental data using a machine learning model to identify usage patterns and generate an optimization plan that minimizes cost based on the rate schedule data;
verify control instructions against comfort constraint parameters stored in a storage device before transmission;
detect anomalous consumption patterns and generate diagnostic recommendations by constructing a prompt data structure and transmitting to a generative neural network model comprising a transformer architecture; and
transmit control instruction data to the plurality of monitoring devices and notification data to a terminal device via the communication interface.

19. The system according to claim 18, wherein the circuitry is further configured to integrate renewable energy generation data and to schedule high-consumption operations during predicted peak generation periods.

20. A method performed by circuitry of a server coupled to a packet-switched network via a communication interface, the method comprising:
receiving, via the communication interface, sensor data from a plurality of monitoring devices installed in a facility;
acquiring external environmental data from one or more external data sources via the packet-switched network;
analyzing the sensor data and the external environmental data to identify usage patterns and generating an optimization plan; and
transmitting control instruction data to the plurality of monitoring devices via the communication interface based on the optimization plan.
